(19) United States
(12) Patent Application Publication
(10) Pub. No.: US 2016/0360919 A1
(43) Pub. Date: Dec. 15, 2016

(54) BEVERAGE BREWING SYSTEMS AND METHODS FOR USING THE SAME

(71) Applicant: Remington Designs, LLC, Valencia, CA (US)

(72) Inventor: BRUCE D. BURROWS, Valencia, CA (US)

(21) Appl. No.: 15/174,339

(22) Filed: Jun. 6, 2016

Related U.S. Application Data
(60) Provisional application No. 62/174,443, filed on Jun. 11, 2015.
(60) Provisional application No. 62/230,508, filed on Jun. 5, 2015.

(51) Int. Cl. A47J 31/60; A47J 31/46; A47J 31/36; A23F 5/26

(52) U.S. Cl. CPC A47J 31/60; A23F 5/26; A47J 31/465; A47J 31/3628

(57) ABSTRACT

A beverage brewing system including one or more features for improving flavor extraction from various beverage materials.

### CROSS REFERENCE TO RELATED APPLICATIONS

This application is related to and claims the benefit of U.S. Provisional Application Ser. No. 61/977,069, filed on Apr. 8, 2014 and entitled “Coffee Brewing System and Method of Using the Same”; U.S. Provisional Application Ser. No. 62/060,282, filed on Oct. 6, 2014 and entitled “Coffee Brewing System and Method of Using the Same”; U.S. Provisional Application Ser. No. 62/069,772, filed on Oct. 28, 2014 and entitled “Coffee Brewing System and Method of Using the Same”; and U.S. Provisional Application Ser. No. 62/136,258, filed on Mar. 20, 2015 and entitled “Coffee Brewing System and Method of Using the Same”; and U.S. Provisional application Ser. No. ______ to Burrows, filed on Jun. 5, 2015, entitled “Beverage Brewing Systems and Methods for Using the Same.”

Each of these applications is fully incorporated by reference herein in its entirety.

### BACKGROUND OF THE DISCLOSURE

Field of the Disclosure

The present disclosure generally relates to beverage and/or liquid food preparation systems, such as beverage brewing systems, and methods for using the same. More specifically, the present disclosure relates to beverage brewing systems designed to brew a beverage from a single-serve or multi-serve brew cartridge, or the like.

Description of the Related Art

There are a wide variety of products on the market for brewing beverages. For example, traditional coffee brewers require consumers to brew an entire multi-serving pot of coffee during a single brew cycle. In recent years, single-serve coffee brewing devices have become a popular alternative because they allow consumers to quickly brew a single serving of coffee. This is particularly ideal for those who want a single cup of coffee on the go. In this respect, consumers no longer have to brew coffee they do not intend to drink.

Many single-serve coffee brewers use air to purge residual water at the end of the brew cycle, and include one pump for displacing brewing water and another pump for displacing purging air. Known coffee brewers also create internal pressure, i.e., within the heater tank and conduits, to force water from the ambient temperature water reservoir, to the heater tank and the brew chamber, and into the coffee cartridge. Conventional brewers typically release this internal pressure only through the inlet needle, which may cause dripping after the end of the brew cycle. Some brewers known in the art attempt to purge the remaining brewed coffee from the lines using air, but the process can be inefficient and can result in continued dripping.

### SUMMARY OF THE DISCLOSURE

Aspects of the present disclosure comprise coupling a vent valve with a pressure-controlled check valve to increase overpressure protection in a brewing system. Other aspects of the present disclosure may include coupling a purge control with a latching system to increase safety and other characteristics of a brewing system.

Other features and advantages of the present disclosure will become apparent from the following more detailed description, when taken in conjunction with the accompanying drawings, which illustrate, by way of example, the principles of the disclosure. Further, the above listing should not be considered limiting, as many different embodiments are possible, and embodiments of the present disclosure can include combinations of the features listed above and/or other features.

### BRIEF DESCRIPTION OF THE DRAWINGS

The accompanying drawings illustrate some embodiments and/or aspects of the present disclosure. In such drawings:

FIG. 1 is a schematic view of one embodiment of a beverage system according to the present disclosure;

FIG. 2 is a perspective view of a pump for use with a beverage system according to the present disclosure;

FIG. 3 is a diagrammatic view of one embodiment of a pump according to the present disclosure which can include a microphone for determining the pump speed;

FIG. 4 is a diagrammatic view of another embodiment of a pump according to the present disclosure which can include a piezoelectric member for monitoring the pump speed;

FIG. 5 is a diagrammatic view of a pump according to the present disclosure which can include a Hall effect sensor for determining the pump speed;

FIG. 6 is a diagrammatic view of a pump according to the present disclosure which can include a slotted disk having an emitter and photoreceptor for determining the pump speed;

FIG. 7 is a schematic view of another embodiment of a beverage system according to the present disclosure;

FIG. 8 is an enlarged schematic view a heater tank according to the present disclosure;

FIG. 8A illustrates an aspect of the present disclosure including a combined vent valve and check valve;

FIGS. 8B-8D illustrate exploded and cutaway views of a combined vent valve and a check valve in accordance with an aspect of the present disclosure;

FIG. 9 is a cross-sectional view of one embodiment of a heater tank water level sensor according to the present disclosure taken generally about the line 9-9 in FIG. 7, illustrating the heater tank in an unfilled state when a disk-shaped float resides below a light beam being transmitted from an emitter to a photoreceptor;

FIG. 10 is a cross-sectional view of an alternative embodiment of a heater tank water level sensor taken generally about the line 10-10 in FIG. 1, illustrating a spherical float biased in a D-shaped cavity;

FIG. 11 is a bottom view of another embodiment of a heater tank water level sensor according to the present disclosure, illustrating a plurality of cavities collectively forming a cavity wherein the spherical float is offset from the central axis of water flow through the heater tank water level sensor;

FIG. 12 is a bottom perspective view of the alternative embodiment of the heater tank water level sensor shown in FIG. 11;

FIG. 13A is a front perspective view of the heater tank water level sensor of FIGS. 11-12;

FIG. 13B is a front perspective view of a heater tank water level sensor similar to FIG. 13A;

FIG. 14 is a diagrammatic view of a heater tank water level sensor similar to FIG. 9, illustrating the photoreceptor receiving the light beam from the emitter when the heater tank is in an unfilled state;

FIG. 15 is a diagrammatic view of the heater tank water level sensor similar to FIG. 14, illustrating the float occluding the photoreceptor from receiving the light beam from the emitter when the heater tank is full;

FIG. 16 is a diagrammatic view of the heater tank water level sensor similar to FIG. 14, illustrating condensation substantially occluding the photoreceptor from receiving the light beam from the emitter when the heater tank is in an unfilled state;

FIG. 17 is a diagrammatic view of an alternate embodiment of the heater tank water level sensor, illustrating the float occluding a bottom-mounted photoreceptor from receiving the light beam from a bottom-mounted emitter when the heater tank is in an unfilled state;

FIG. 18 is a diagrammatic view of the heater tank water level sensor similar to FIG. 17, illustrating the bottom-mounted photoreceptor receiving the light beam from the bottom-mounted emitter;

FIGS. 18A, 18B, 19A, and 19B illustrate aspects of inlet needles in one or more aspects of the present disclosure;

FIG. 19 is a schematic view of another beverage system according to the present disclosure;

FIG. 20 is a diagrammatic view of a microcontroller according to the present disclosure that can operate embodiments of brewing systems according to the present disclosure;

FIGS. 20A and 20B illustrate a latching mechanism in accordance with an aspect of the present disclosure;

FIGS. 20C and 20D illustrate purge mechanisms and a combined latching/purge mechanism in accordance with aspects of the present disclosure;

FIG. 21 is a flow chart illustrating one embodiment of a method according to the present disclosure for using the beverage system in accordance with one embodiment;

FIG. 22 is a flow chart illustrating one embodiment of a method according to the present disclosure for using the heater tank water level sensor for determining when the heater tank is full of water;

FIG. 23 is a flow chart illustrating some possible steps of one embodiment of a method according to the present disclosure for regulating pump voltage when delivering liquid to a cartridge;

FIG. 24 is a flow chart illustrating some possible steps of one embodiment of a method according to the present disclosure for purging water and liquid from the head conduit; and

FIG. 25 is a flow chart illustrating some possible steps of one embodiment of a method according to the present disclosure for opening the head conduit to atmospheric pressure to reduce or eliminate dripping from the head.

### DETAILED DESCRIPTION OF THE DISCLOSURE

### Overview

Brewing coffee, tea, and other beverages has become a more common occurrence in society for people of all ages. Many shops use commercial grade machines to brew espresso, coffee, and tea, and specialty retailers also prepare other types of beverages using various beverage materials and different brewing techniques. Consumers enjoy the enhanced and different flavors that these machines are able to extract from various beverage materials. However, the commercial machines used in coffee shops and other retailers are often too large and expensive for home use.

### Single-Serve Brewing Machines

For some of the most consumed beverages, e.g., brewed coffee, many devices have been employed in consumer homes. Percolators, drip machines, pod machines, presses, and other types of small appliances are often used. These machines allow for some variation in brewing characteristics for individual consumers, e.g., different amounts or types of coffee, different amounts or temperatures of water used in brewing, and different techniques to attempt to extract various flavors from coffee, tea, or other brewing materials. Although the discussions herein are mostly directed to the brewing or other methods of brewing coffee, similar methods may be applied to tea, soup, or other beverages or foods within the scope of the present disclosure. The use herein of a specific beverage material, e.g., coffee, and a specific type of extraction, e.g., brewing, to assist in the explanation of aspects of the present disclosure does not limit the use, scope, and/or breadth of the present disclosure in the beverage production industry or in any other industry where similar controls or machines may be employed.

More recently, individual servings of coffee in sealed containers, have been used with small specialty brewing devices, which may be referred to as “single-serve brewing machines” or “single-serve brewers” to more closely approximate flavors from commercial grade machines. These machines also allow for quick preparation of single servings of coffee or other beverages. Further, the sealed containers allow for easy clean-up after brewing as the coffee grounds are confined within the container after brewing.

Because these single-serve brewing machines are becoming more popular, consumers are attempting to utilize a wider range of materials in the sealed containers. The single-serve brewing machines in the related art are often not capable of this wider range of materials, and, as such, are limited to the types and/or materials provided by certain manufacturers that are solely provided by specific manufacturers.

Further, consumers would like to use their own materials in single-serve brewing machines, where a reusable container may be employed and filled with brewing materials of the consumer's choosing. However, single-serve machines in the related art either will not accept these containers, are not provided with enough capability to determine the type of material the consumer is using, or are not user-programmable to enable the single-serve brewing machines to vary the characteristics or functions performed by the single-serve brewing machines to process the consumer-selected material in an appropriate fashion.

### Brewing System Diagram

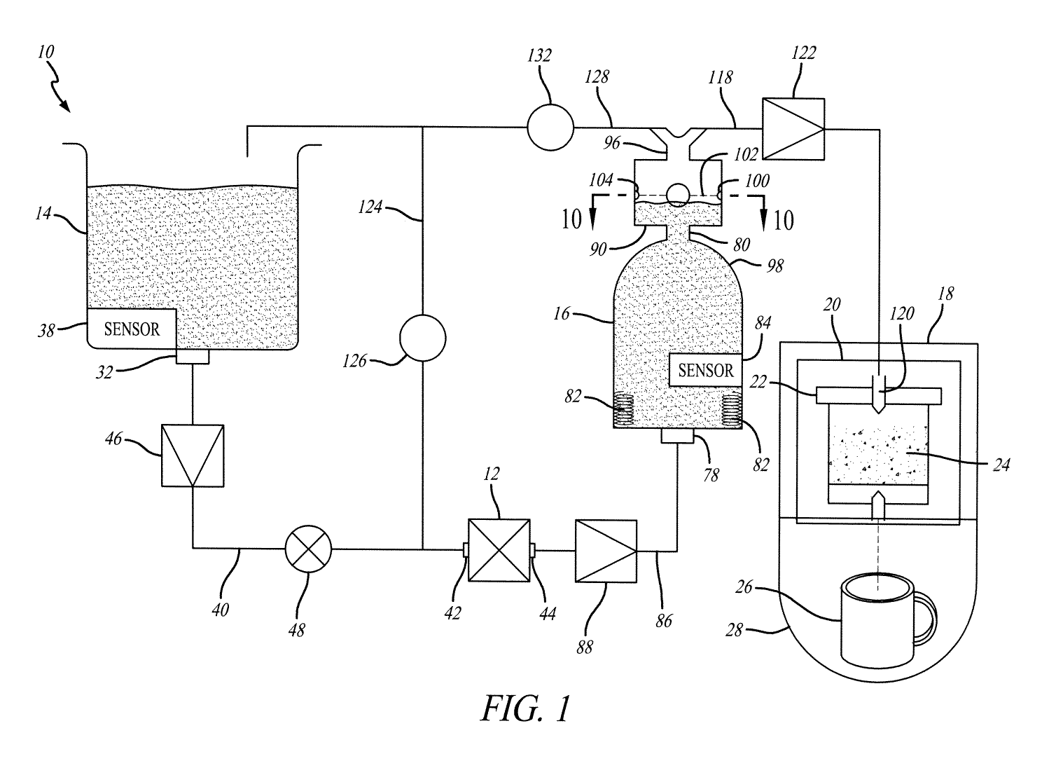

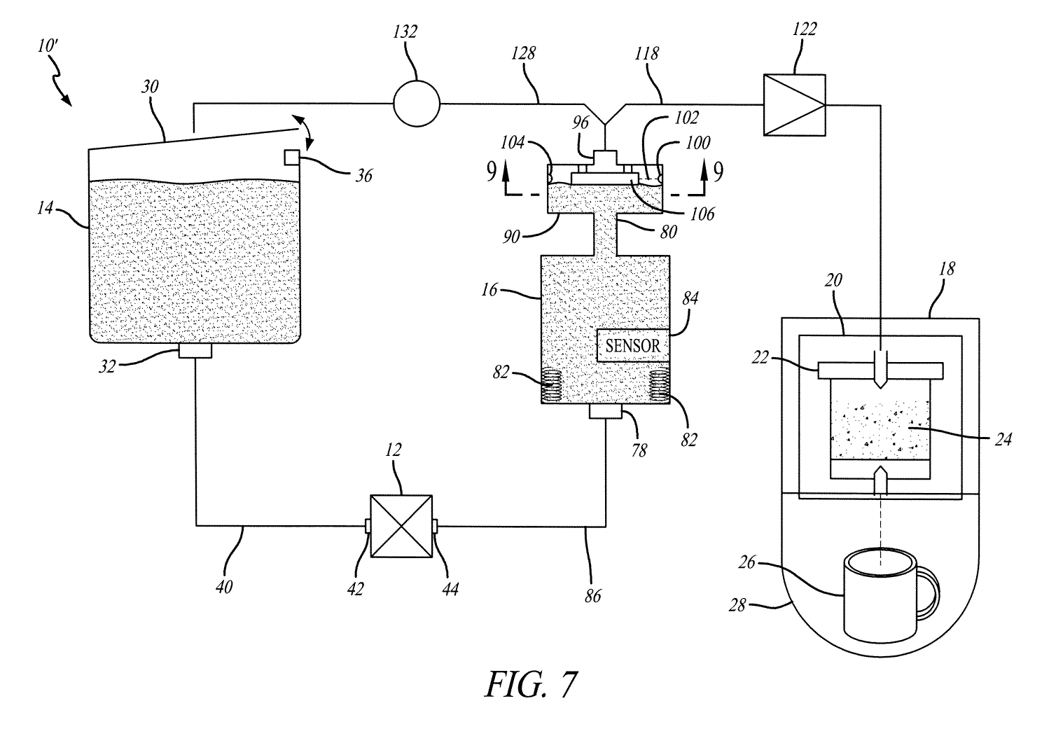

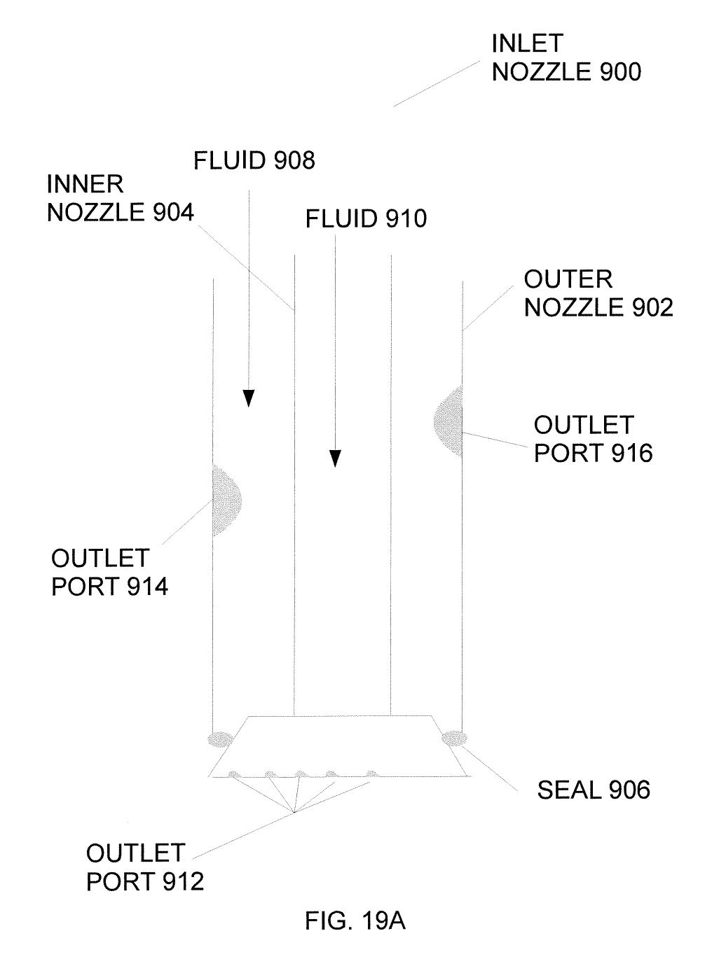

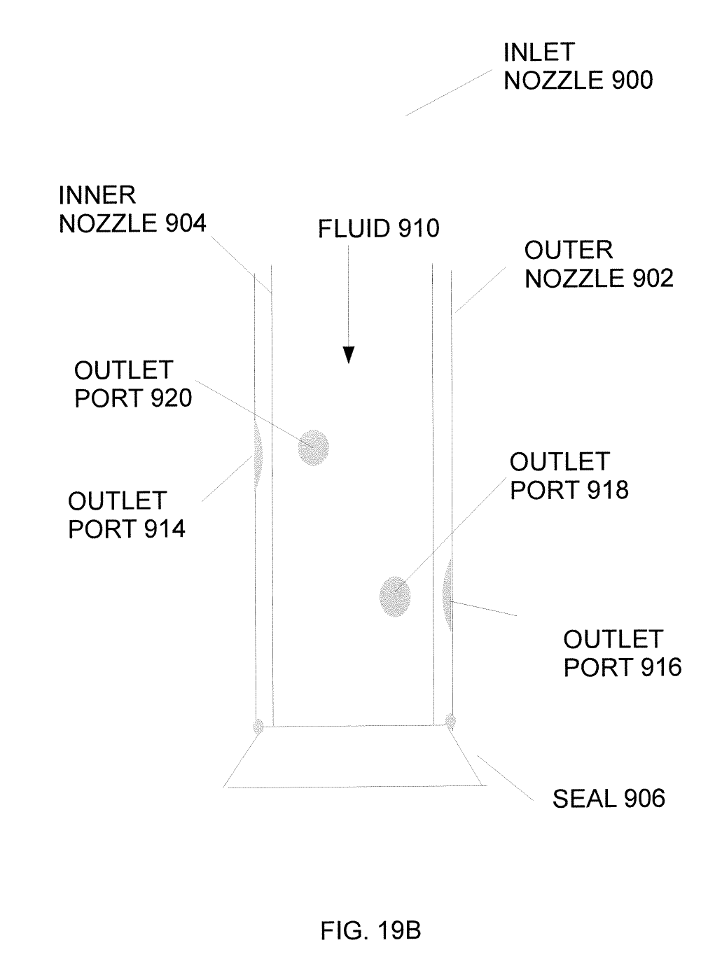

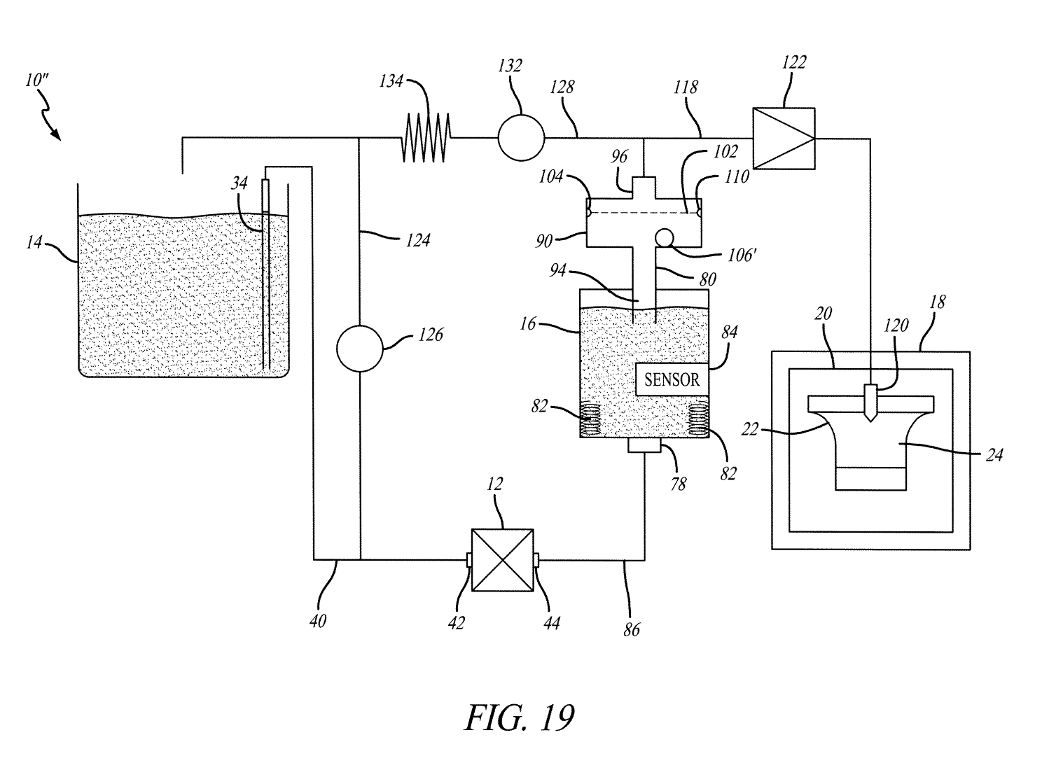

As shown in the drawings for the purposes of illustration, the present disclosure for a beverage system, such as a beverage brewing system, is referred to generally by the reference numeral 10 in FIG. 1, and alternative beverage brewer systems are referred to generally by reference numbers 10′ and 10″ in FIGS. 7 and 19, respectively. As illustrated in FIG. 1, the beverage brewing system 10 can generally include a pump 12 that can be configured to pump unheated water from an ambient temperature water reservoir 14 to a heater tank 16, which can heat the water to a desired temperature (referred to herein as a “brewing temperature,” although other temperature types—e.g., “mixing temperature,” “soup temperature,” etc.—are possible, and this term should not be construed as limiting) for eventual delivery to a head 18 (referred to herein as a “brew head,” although many different types of heads are possible and this term should not be construed as limiting). The brew head 18 can include a chamber 20 (e.g., a “brew chamber”) that can house a cartridge 22 (e.g., a “brew cartridge”) containing a single-serve or a multi-serve amount of a beverage medium 24, such as coffee grounds, tea, hot chocolate, lemonade, etc., for producing a beverage dispensed from the brew head 18. The beverage can be dispensed into an underlying container, such as a mug 26 or other similar container (e.g., a carafe) which can be placed on a platen 28, as part of a brew cycle.

More specifically, the reservoir 14 stores ambient temperature water used to brew a cup or multiple cups of beverage (e.g., coffee) in accordance with the embodiments and processes disclosed herein. Embodiments utilizing water at temperatures other than ambient are also possible, such as but not limited to pre-heated water that is hotter than ambient. The reservoir 14 is preferably top accessible for pour-in reception of water and may include a pivotable or fully removable lid 30 (FIG. 7) or other closure mechanism that provides a watertight seal for the water in the reservoir 14. The water preferably exits the reservoir 14 during the brew process via an outlet 32 at the bottom thereof (FIGS. 1 and 7). Although, the water may exit the reservoir 14 from locations other than the bottom, such as the sides or the top such as via a reservoir pickup 34 extending down into the reservoir 14 (FIG. 19), or other locations as desired or feasible. In one embodiment, the reservoir 14 includes a water level sensor 38 (FIG. 1) for measuring the volume of water present therein. An optional reservoir closure switch 36 (FIG. 7), such as a Hall effect sensor or the like, may detect whether the reservoir 14 is sealed by the lid 30, and may correspond with the brewer circuitry to prevent initiation of the brew cycle in the event the lid 30 is open as shown in FIG. 7. The reservoir 14 is preferably sized to hold a sufficient quantity of water to brew at least one cup of brewed beverage, e.g., a 6 ounce (“oz.”) cup of coffee. Although, while the reservoir 14 could be of any size or shape, it preferably holds enough water to brew more than 6 oz., such as 8, 10, 12, 14 oz. or more. Of course, the water reservoir 14 could be replaced by other water sources, such as a water main.

Advantageously, in some embodiments of the present disclosure the pump 12 can be used for the dual purpose of pressurizing and/or pumping water (e.g., from the reservoir 14 to the brew cartridge 22) and/or for pressurizing and pumping air (e.g., for efficiently purging remaining water or brewed beverage from the system 10, such as near, at, or after the end of the brew cycle). In this respect, the pump 12 can initially pump water from the reservoir 14 through a first conduit 40 to the heater tank 16 where the water can be pre-heated to a predetermined brew temperature before delivery to the brew cartridge 22 to brew the beverage medium 24. At, near, or after the end of the brew cycle, the pump 12 pumps pressurized air through the system 10 to purge any remaining water or brewed beverage therein to substantially reduce and preferably eliminate dripping at the end of the brew cycle. As such, the preferred pump 12 is able to operate in both wet and dry conditions, i.e., the pump 12 can switch between pumping water and air without undue wear and tear. Accordingly, the preferred pump 12 eliminates the need for a two-pump system, thereby reducing the overall complexity of the brewing system 10, and is advantageous over conventional systems that require one pump for water and a second pump for purging the remaining fluid with air.

### Brewing Variables and Control

Many variables exist within system 10 that may affect the overall performance of system 10. One variable is the water level in the reservoir 14. Another variable may be the heater 82 operation in the heater tank 16. Another variable may be the back pressure from the cartridge 22 that may partially close the check valve 122. Other variables may also exist. Each of these variables may be at least partially accounted for through microcontroller 50 to produce a more consistent performance in system 10.

Hydrostatic Pressure

Within reservoir 14, or, if system 10 is coupled to a water main, the pressure at outlet 32 and against the flow direction of check valve 46 may vary. Although pump 12 delivers a constant volume of liquid per rotation as described herein, the monitoring of the current draw by pump 12 may not be sufficient to determine the pressure differential across pump 12.

The voltage delivered to pump 12 may be clamped such that the current delivered to operate pump 12 determines the speed and timing of each rotation of pump 12. The number of windings on the stator of pump 12 may vary from pump to pump, and, as such, a calibration for each pump may be made to determine the current drawn by each pump prior to installation in system 10.

The current spikes occur at specific times during the rotation of the rotor of pump 12, i.e., when the electric field within the windings of the stator is interfered with by the magnets or other metallic portions of the rotor. These current spikes may correspond to the movement of the pistons in pump 12, or may be calibrated to determine any delay between the current spikes and the full displacement of one or more of the pistons in pump 12.

Between the current spikes, it may not be necessary to clamp the voltage delivered to pump 12, as the times in between the current spikes are not drawing enough power to overload or otherwise damage pump 12. As such, the voltage across pump 12 may be unclamped and measured. This voltage shows the rest pressure in conduit 40, which is related to the hydrostatic pressure created by the water level in reservoir 14.

In other words, the minimum pressure, or diastolic pressure at inlet 42 of pump 12, created by the water level in reservoir 14 or in any other manner, can be determined by measuring the voltage, current, or other characteristics of pump 12 when pump 12 is at or near the point equidistance from the maximum pump displacement (in one embodiment at the minimum pump displacement), similar to systolic pressure in the heart, at outlet 44 of pump 12. Microcontroller 50 or other similar means may take the measurements into account to change the amount of fluid delivered to heater tank 16, and ultimately to cartridge 22, to produce a more consistent fluid flow within system 10.

Heater Operation

In the embodiment shown, check valve 88 controls the minimum pressure entering heater tank 16, and check valve 122 controls the minimum pressure leaving heater tank 16 to be delivered to needle 120 and cartridge 22. However, the actual pressure may be much more than the minimum cracking pressure that check valve 122 will accept. Because this pressure is, other than a minimum value, uncontrolled, additional pressure and/or liquid may be delivered to cartridge 22, causing inconsistent results for system 10.

For example, and not by way of limitation, when a brew cycle starts, check valve 122 has obtained a minimum cracking pressure and fluid flows through needle 120 into cartridge 22. If, during the brew cycle, heating element(s) 82 are energized, the pressure in heater tank will rise, thus creating additional pressure through check valve 122. Since this additional pressure may not be controlled by check valve 122, or vented through vent 128, the additional pressure may be delivered through needle 120 to cartridge 22. For the next brew cycle, heating element 82 may not be energized (or may be energized less), and thus the additional pressure and/or fluid caused by expansion of water due to the additional heat from heating element(s) 82 will not (or will only to a lesser extent) be delivered to the next cartridge 22. Since the beverage mediums 24 received different pressures, the tastes, temperatures, or other characteristics to be gleaned from the beverage mediums 24 may be different.

To reduce the difference in pressure, the present disclosure may employ microcontroller 50 or other means to monitor current delivered to heating element(s) 82, and adjust the time that fluid is delivered to needle 120 accordingly. The present disclosure may also employ microcontroller 50 to monitor the difference in pressure delivered to check valve 122 in other ways, e.g., temperature measurement, pressure measurement at the input to check valve 122, etc., to vary the time fluid is delivered or other aspects of system 10 to obtain more consistent results.

Cartridge Backpressure

Once pierced by needle 120, each cartridge 22 provides resistance to the flow of fluid through cartridge 22 to mug 26. This resistance varies based on, among other things, the beverage medium within cartridge 22. For example, and not by way of limitation, bouillon within cartridge 24 may provide less resistance to fluid flow than ground coffee, because bouillon dissolves in the heated fluid from needle 120 while coffee grounds do not.

The pressure drop across the beverage medium 24 can result in back pressure against the outlet of check valve 122. If this back pressure is high enough (e.g., equal to or greater than the difference in pressure between the inlet and outlet of the check valve 122), check valve 122 may close, or cartridge 22 (or filter paper that is internal to cartridge 22) may be “blown out” by the pressure created by the incoming pressure of the heated fluid through needle 120.

Because cartridge 22 can only withstand a certain amount of pressure, and to minimize the chance of failure of cartridges 22, microcontroller 50 may monitor the position of check valve 122 (such as through a sensor), and/or there may be a coupling of check valve 122 and vent 132.

Brewing Process

In many brewing processes, there are several variables that affect flavor extraction from brewing materials. For example, and not by way of limitation, a brewing machine may heat water for a certain amount of time, called the heating time, and pass water through a brewing material (e.g., coffee) for a certain amount of time called the brewing time. However, if the only variable that is controlled by the brewing machine is time for the heating time and brewing time, the brewing machine likely does not take into account the ambient or prior temperature of the water, the hardness or other minerals present in the water, the amount of water in the machine, and/or the pressure that the water is being delivered at, among other things. Further, during the brew cycle, a simple timer likely does not take into account the amount, grind, density, or actual temperature of the water as the water passes through the brewing material.

As such, a device or system in accordance with the present disclosure may take several variables into account for brewing different materials in different ways. Further, a device or system in accordance with the present disclosure may take into account one or more variables that may change during and/or between brewing cycles.

A brewing cycle may comprise, for example, several different periods of time. The conditions of the water, brewing material, and/or brewing machine may be determined, approximated, measured, interpolated, extrapolated, or otherwise taken into account prior to a request for brewing by a consumer or user. For example, and not by way of limitation, the temperature of the water in a reservoir, heater tank, or other area may be measured to determine how long a heating element should be energized to heat the water to a desired temperature, etc. Such initial conditions of the water, brewing material, system parameters, and other conditions prior to delivery of the water to the brewing material may be referred to as the “pre-brewing period” of a brew cycle herein.

Another period within the brewing cycle may be referred to as the “brew period” of the brew cycle. The brew period is the time during the brew cycle that water is delivered to the brewing material. As with the pre-brewing period, conditions of the water, brewing materials, system parameters, and other conditions during delivery of the water to the brewing materials may be monitored, measured, or otherwise inferred or determined to more precisely control the conditions for brewing during the brew period. For example, and not by way of limitation, the water temperature may be measured and/or controlled after being heated to provide a consistent water temperature to the brewing material, etc.

Another period during the brew cycle may be referred to as the “purge period.” The purge period may be employed to remove water or other materials from the brewing device. For example, and not by way of limitation, the brewing machine may change the flow of water within the brewing device to stop delivery of the heated water to the brewing material and pump air through the tubing, pumps, and other pipes inside the brewing machine to reduce or eliminate dripping from the machine after the desired beverage has been brewed.

A brewing device in accordance with the present disclosure can determine, measure, infer, or otherwise determine one or more conditions of one or more of the brewing variables, e.g., water temperature, pressure, backpressure, amount or type of brewing material, time, time of water delivery, amount of water delivery, amount of water delivery at temperature, purge time, pre-existing conditions, and/or other characteristics that may control brewing performance for one or more brewing materials used in the brewing machine.

### Pump Operation

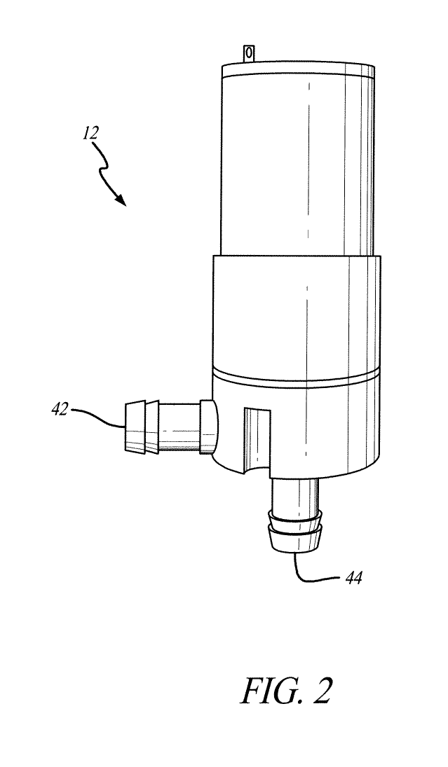

More specifically, FIG. 2 illustrates one preferred embodiment of the pump 12 for use with the brewing system 10. As shown, the pump 12 includes an inlet 42 for receiving a quantity of fluid and an outlet 44 for discharging pressurized fluid therefrom. The pump 12 is preferably a positive displacement pump such as a tri-chamber diaphragm pump or other diaphragm pump. Alternatively, the pump 12 may be a non-positive displacement pump such as a centrifugal pump. Preferably, the pump 12 can alternate between pumping air and/or water and carries an operational lifespan commensurate in scope with the normal operating lifespan of conventional beverage brewers.

As shown in FIGS. 1, 7, and 19, the first conduit 40 fluidly couples the reservoir 14 to the pump 12. In one embodiment shown in FIG. 1, the first conduit 40 may carry water from the reservoir 14, through a first check valve 46 and an optional flow meter 48 to the pump inlet 42. The first check valve 46 is preferably a one-way check valve that only permits forward flow from the reservoir 14 to the pump 12 when in a first position, and otherwise prevents fluid from flowing in the reverse direction (i.e., backwards) back toward the reservoir 14 when in a second position. Moreover, the first check valve 46 has a positive cracking pressure (i.e., a positive forward threshold pressure needed to open the valve). As such, the first check valve 46 is generally biased in a closed position unless the positive forward flow (e.g., induced by the pump 12) exceeds the cracking pressure. For example, the first check valve 46 may have a cracking pressure of 2 pounds per square inch (“psi”). Thus, the pressure pulling fluid through the first conduit 40 must exceed 2 psi to open the first check valve 46 for fluid to flow therethrough. In this respect, water from the reservoir 14 will not flow past the first check valve 46 unless the pump 12 pressurizes the first conduit 40 to at least 2 psi. The cracking pressure may vary depending on the specific pump and/or other components used.

As briefly mentioned above, in the embodiment illustrated in FIG. 1, the beverage brewing system 10 includes the flow meter 48 disposed between the first check valve 46 and the pump 12 for measuring the volume of water pumped from the water reservoir 14 to the heater tank 16. In one aspect, the flow meter 48 may measure the quantity of water required to initially fill the heater tank 16. Additionally or alternatively, once the heater tank 16 is full, the flow meter 48 may measure the quantity of water delivered to the brew cartridge 22 in real-time during a brew cycle. This information is important, as it can allow the system 10 to set and track the amount of beverage to be brewed during the brew cycle. Thus, a user is able to select the desired quantity of beverage to brew (e.g., 6, 8, 10, 12 oz. or more) for any one brew cycle. In essence, the flow meter 48 ensures that the pump 12 displaces the correct amount of water (i.e., the desired serving size) from the reservoir 14 to the brew cartridge 22. The flow meter 48 is preferably a Hall effect sensor, but may be any type of flow meter known in the art. Alternately, the flow meter 48 may be positioned on the outlet side of the pump 12.

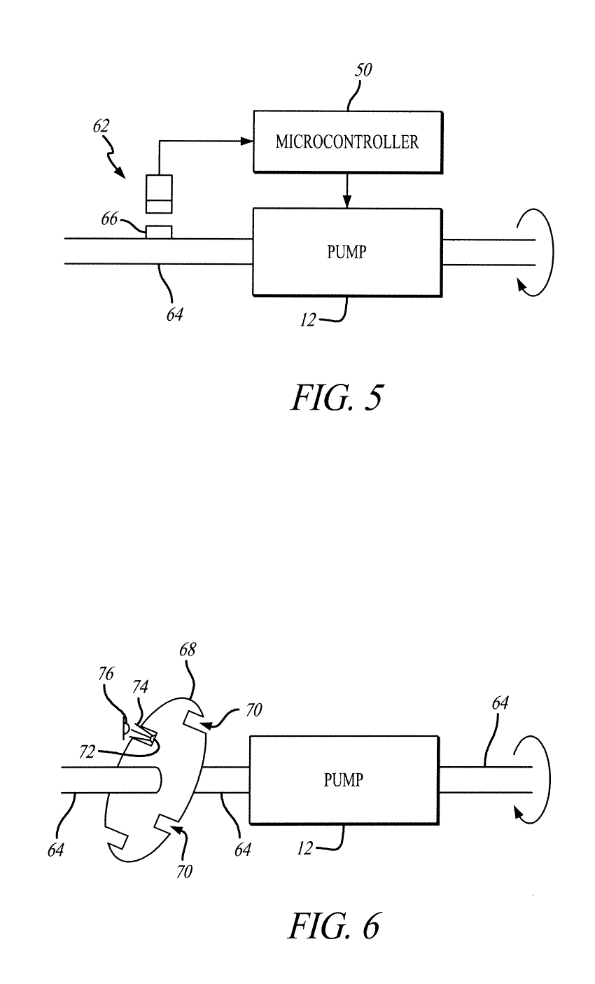

In alternate embodiments, the beverage brewing system 10 may use the pump 12 to determine the volume of water transferred from the reservoir 14 to the heater tank 16 and/or the brew cartridge 22, thus eliminating the need for the flow meter 48. The system 10 may monitor the rotational speed of the pump 12 by way of electrical signal feedback to a microcontroller 50, such as that shown in FIG. 5, to determine the speed (e.g., in revolutions-per-minute, or “rpm”) at which the pump 12 is operating. This is similar to the use of a tachometer. In this respect, the system 10 can determine the rotational speed of the pump 12 based on the amount of current the pump 12 draws. Each revolution of a positive displacement pump causes a predetermined quantity of fluid to pass therethrough. So, if the pump 12 is a tri-chamber diaphragm pump, the system 10, and specifically the microcontroller 50 from FIG. 5, can know that each revolution of the pump 12 displaces three times the amount of fluid that fills each diaphragm. Put another way, a ⅓ revolution would displace an amount of fluid equal to volume of the cavity of one diaphragm. In this manner, by monitoring the rotational speed of the pump 12, the beverage brewing system 10 can determine the total volume of water displaced through the pump 12 based on the pump runtime (e.g., fluid quantity=pump rate*fluid volume/revolution*time). For example, if the pump 12 runs for 1 minute at 500 rpm and each revolution displaces 0.02 ounces of fluid, the beverage brewing system 10 may determine therefrom that the pump 12 pumped a total of 10 ounces of fluid (i.e., water during a brew cycle). In another similar embodiment, current spikes can be monitored. Each pump current spike can be correlated to an amount of water displaced (e.g., the volume of liquid in one diaphragm), and thus the total volume displacement (and thus flowrate) can be calculated. The pump speed, runtime, and displacement may vary depending on the type and size of pump selected and depending on the type of the beverage brewing system 10. The above is just one example of many different combinations that may be utilized with the system 10 disclosed herein.

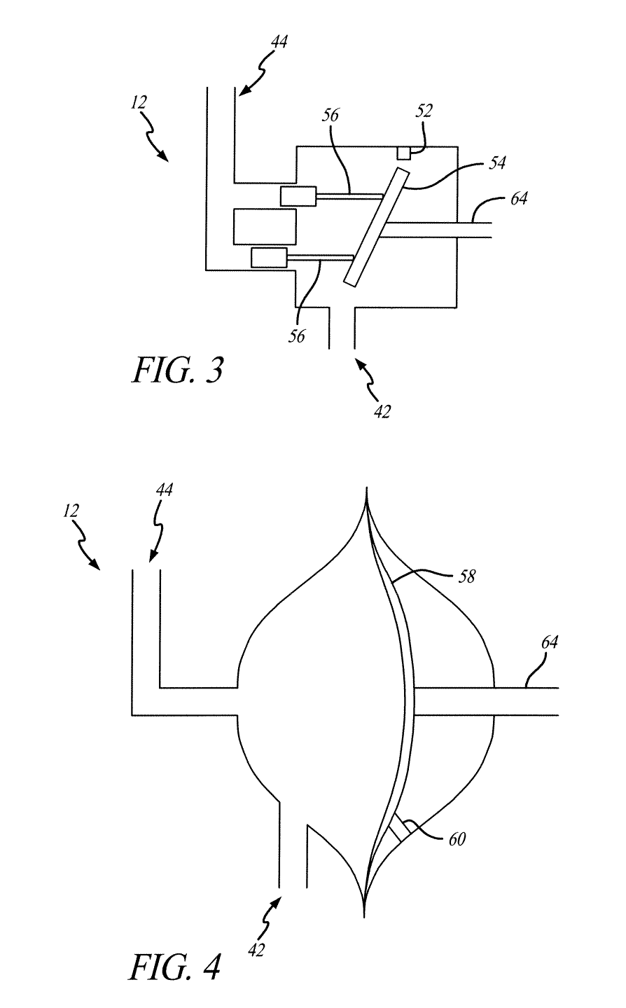

For example, in further embodiments, the system 10 may determine the rotational speed of the pump 12 by methods unrelated to reading the current that the pump 12 draws. For example, as illustrated in FIG. 3, the system 10 may include a microphone 52 that listens for sound pulses or vibrations generated when one or more rotary wobble plates 54 hit one or more pistons 56. In this respect, the system 10 may be able to deduce the speed of the pump 12 based on the rate of sound pulses or vibrations picked up or heard by the microphone 52. The flow rate may then be calculated as mentioned above, i.e., the total volume of water displaced through the pump 12 being based on the formula: fluid quantity=pump rate*fluid volume/revolution*time; wherein the pump rate is measured by the microphone 52 based on the rate of sound pulses or vibrations and the fluid volume is the volume of water displaced by the pump 12 for each revolution. The microphone 52 may be any suitable type of microphone, such as a field-effect transistor (FET) microphone or a piezo microphone.

Alternately, as illustrated in FIG. 4, a diaphragm 58 of the pump 12 may contact a piezoelectric member 60 during each pumping cycle or revolution, thereby inducing a measurable electric current therein. In this respect, the speed of the pump 12 can be measured by the rate the current is induced in the piezoelectric member 60 over a given time period (i.e., the number of times that the diaphragm 58 hits the piezoelectric member 60). The piezoelectric member 60 is preferably made from polyvinylidene fluoride, but may be made from any other type of piezoelectric material known in the art. In another embodiment shown in FIG. 5, the microcontroller 50 uses a Hall effect sensor 62 to determine the speed of the pump 12. In this respect, the pump shaft 64 has a magnet 66 disposed thereon. When the magnet 66 passes by the Hall effect sensor 62, an electric current is induced therein. The speed of the pump 12 is similarly calculated based on the rate that the electric current is induced in the Hall effect sensor 62.

Another alternative embodiment is shown in FIG. 6, which illustrates a disk 68 having a plurality of circumferential slots 70 (which can be evenly spaced) affixed to and rotating with the pump shaft 64. An emitter 72 disposed on one side of the disk 68 shines a light beam 74 for periodic reception by a photoreceptor 76 on the other side of the disk when aligned with one of the slots 70 in the disk 68. Again, periodic reception by the photoreceptor 76 of the light beam 74 through the slots 70 generates a periodic and measurable signal indicative of the speed of the pump 12. For example, the microcontroller 50 may determine the speed of the pump 12 by dividing the number of times that photoreceptor 76 receives the light beam 74 from the emitter 72 in a specified time period, and based on the number of slots 70 in the disk 68. The emitter 72 is preferably an LED, but may be any suitable light source known in the art.

### Heating Operation

Before initiation of a brew cycle, a heater tank according to the present disclosure (such as the heater tank 16 from FIG. 1) can be designed to heat the ambient temperature water pumped from the reservoir 14 to a temperature sufficient for brewing a beverage (e.g., 195° Fahrenheit or 90° Celsius for brewing coffee). More specifically, as shown in FIGS. 1, 7, 8 and 19, the heater tank 16 includes an inlet 78 for receiving an inflow of unheated water, an outlet 80 for discharging heated water, and a heating element 82 for heating the water for eventual use to brew the beverage medium 24 in the brew cartridge 22. Preferably, the inlet 78 and the heating element 82 are disposed substantially at the bottom of the heater tank 16 as shown in FIGS. 1, 7, 8 and 19. The water heated by the heating element 82 rises because it is less dense than the cooler water (e.g., room temperature) displaced from the reservoir 14. As heated water rises within the tank 16, cooler water therein tends to fall. This ensures constant heating of the coolest water in the tank 16. Even if the inlet 78 were placed at the top of the tank 16, it would be preferred that ambient temperature water from the reservoir 14 flow directly over or past one or more of the heating elements 82, to ensure proper heating. For example, in an embodiment where the inlet 78 is at the top of the tank 16, a first heating element (not shown) may be placed at or near the entrance to pre-heat water entering the tank 16, while the heating element 82 may be placed at the bottom thereof to ensure continued heating. The heating element 82 is preferably a series of electrically resistive coils, but may be any type of heating element known in the art. The heater tank 16 may further include a temperature sensor 84, such as a thermistor, for measuring the temperature of the water in the heater tank 16. The temperature sensor 84 allows the beverage brewing system 10 to maintain the appropriate brewing temperature (e.g., 195° Fahrenheit for coffee) in the heater tank 16. The heater tank 16 may be any size, and can be large enough to hold enough water to adequately brew the largest serving size.

Further with respect to FIGS. 1, 7, and 19, fluid displaced by the pump 12 travels through a second conduit 86 fluidly coupling the pump outlet 44 to the bottom of the heater tank 16 at the inlet 78. A second check valve 88 (FIG. 1) may be disposed between the pump 12 and the inlet 78 in series with the second conduit 86 to prevent heated water in the heater tank 16 from flowing back toward the pump 12. The second check valve 88 is preferably a one-way check valve having a positive cracking pressure (e.g., 2 psi) similar to the first check valve 46. As such, fluid cannot flow to the heater tank 16 unless it exceeds the cracking pressure of the second check valve 88. Of course, the second check valve 88 may have different specifications than the first check valve 46, including a different cracking pressure.

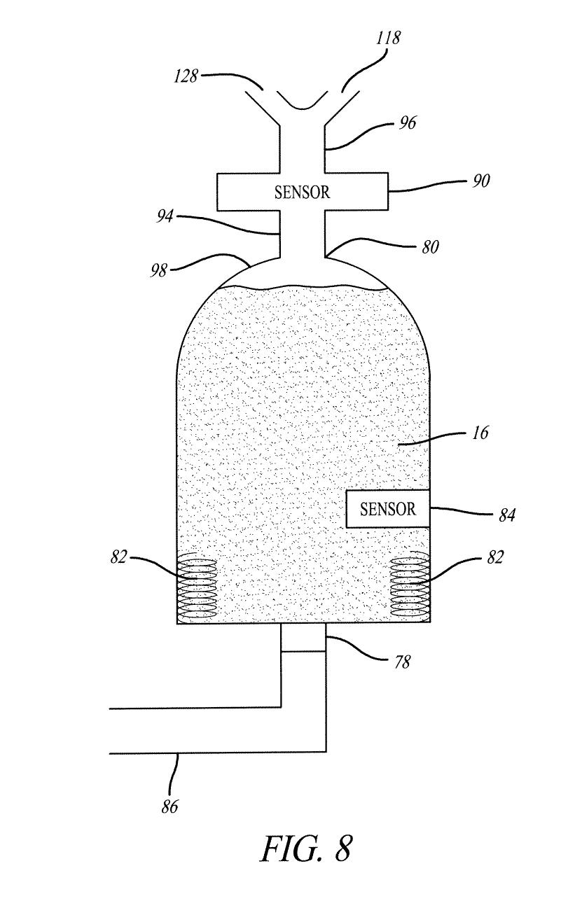

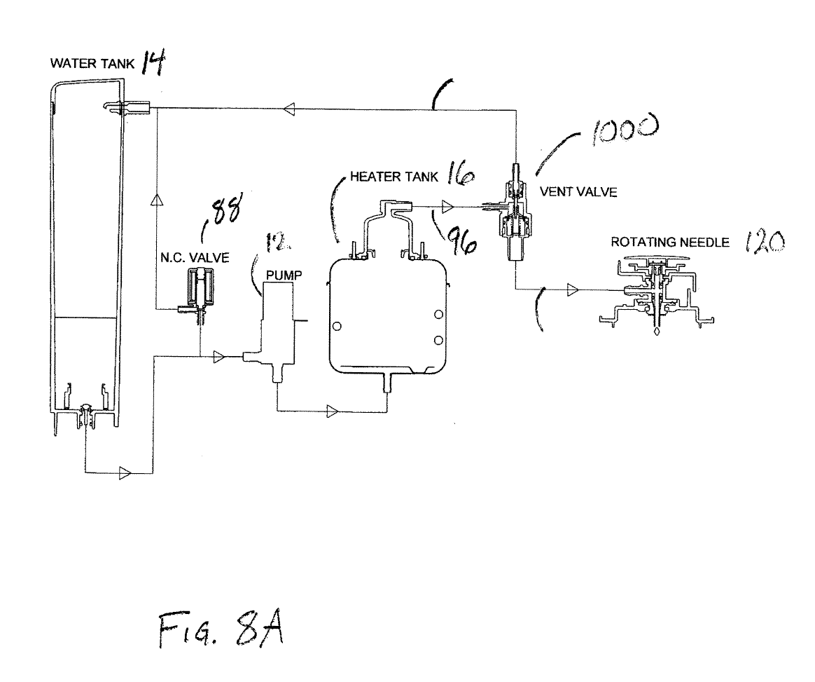

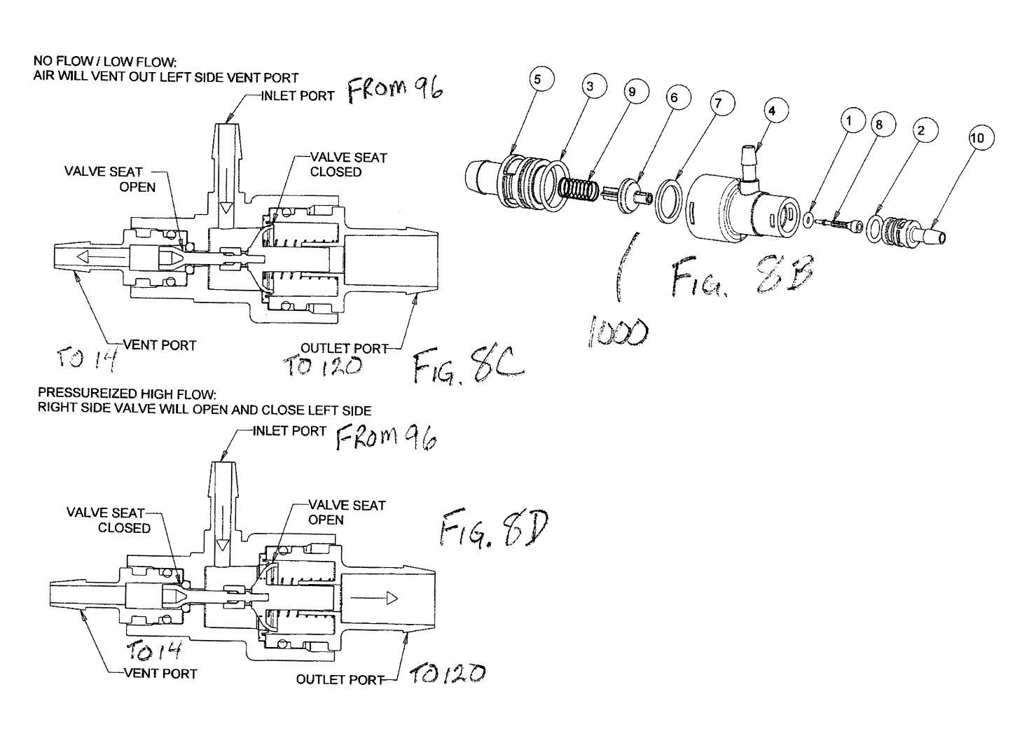

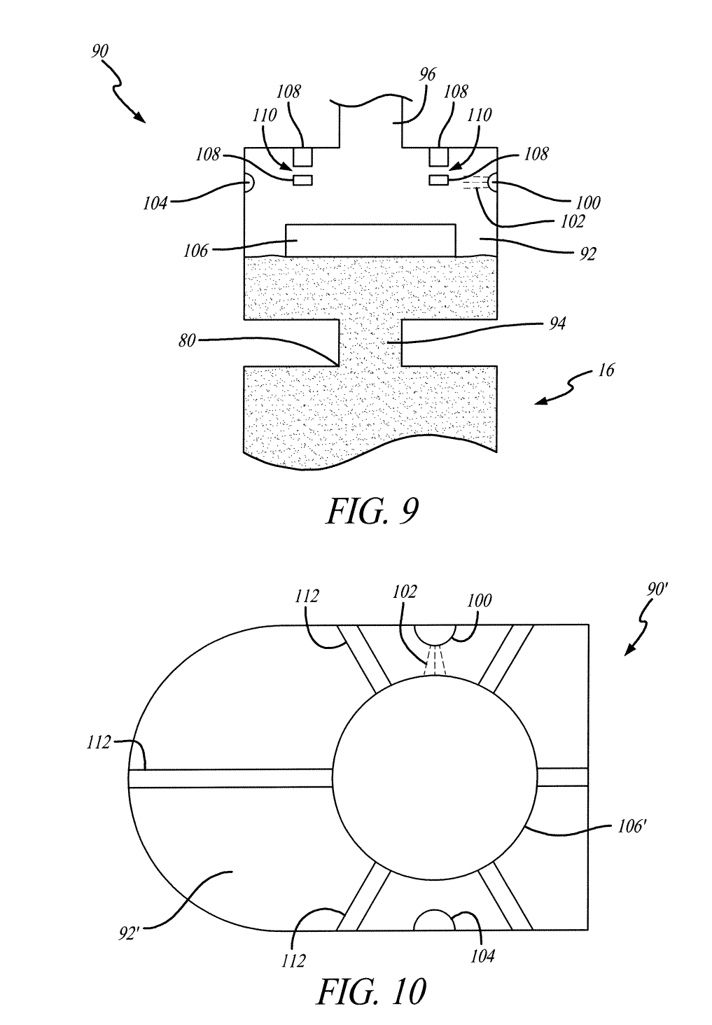

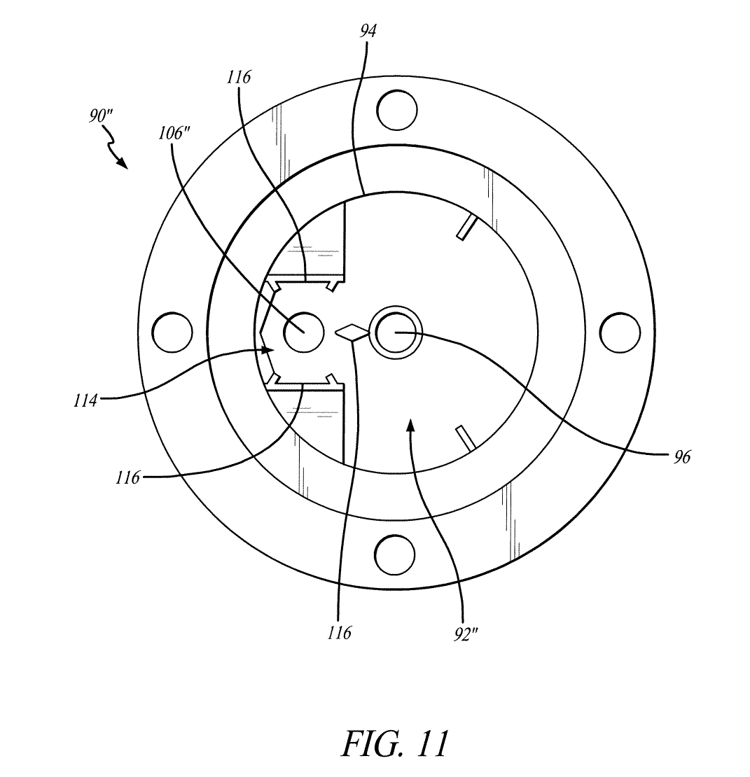

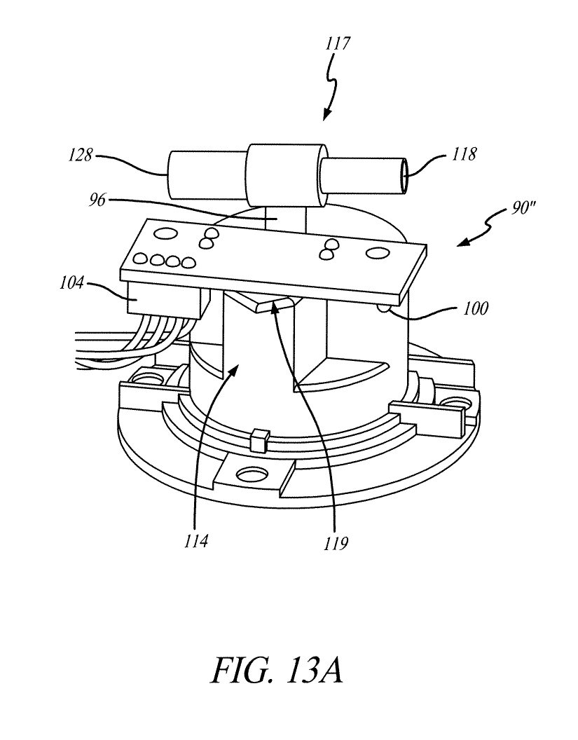

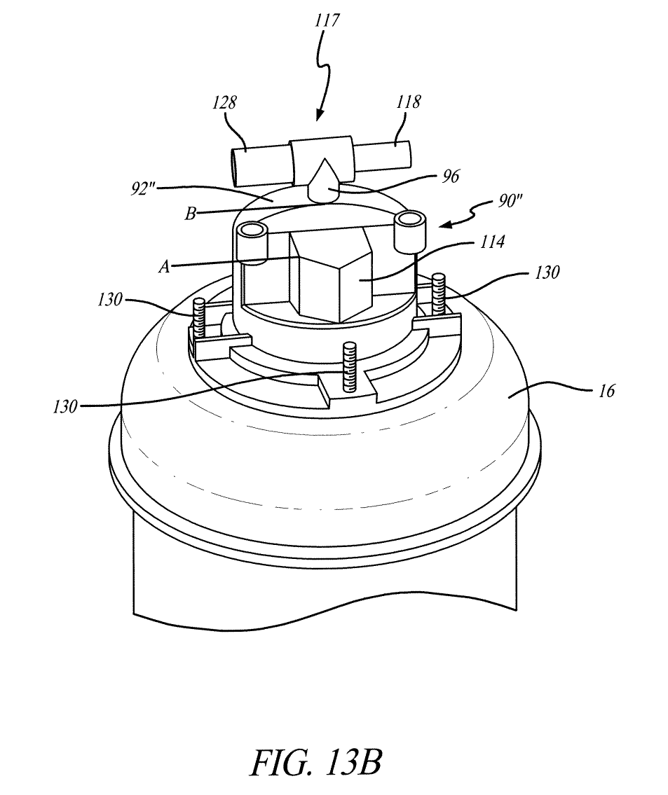

Additionally, the beverage brewing system 10 may include a heater tank water level sensor 90 for determining the level of water in the heater tank 16. In one embodiment, as illustrated in FIG. 9, the sensor 90 includes a substantially cylindrical cavity 92 having an inlet pickup 94 on one side that extends down into the heater tank outlet 80 and an outlet 96 on the other side, as described in more detail below. Although, the inlet pickup 94 is preferably coupled to or formed from the dome-shaped nose 98, as shown in the embodiment of FIG. 8, to funnel water and air out therefrom. That is, the inlet pickup 94 may not necessarily extend down into the top of the heater tank 16, but rather be formed from the general shape of the heater tank 16. The sensor 90 preferably includes an emitter 100, such as an LED, disposed on one side of the cavity 92 for emitting a light beam 102 across at least a portion of the cavity 92 for reception by a photoreceptor 104. The emitter 100 and the photoreceptor 104 may be disposed within the cavity 92 as shown in FIGS. 9 and 10 or external to the cavity 92 (as shown in FIG. 13a), so long as the light beam 102 can be transmitted therebetween. In the embodiment shown in FIG. 9, the emitter 100 and the photoreceptor 104 are disposed on the vertical sides of the sensor housing, while the inlet pickup 94 and the outlet 96 extend from the bottom and top portions of the sensor 90, respectively.

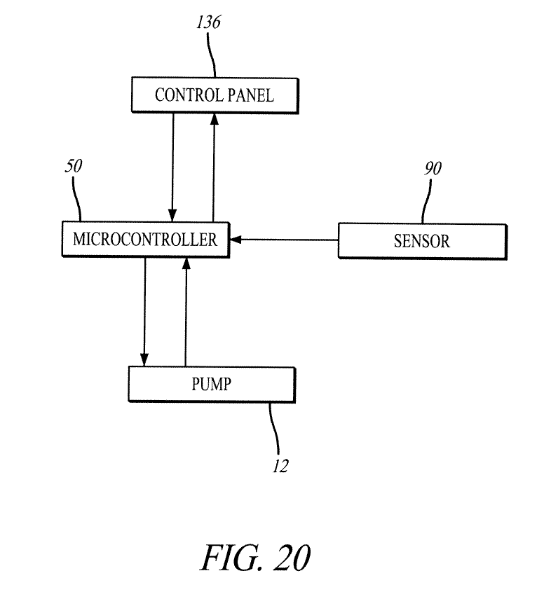

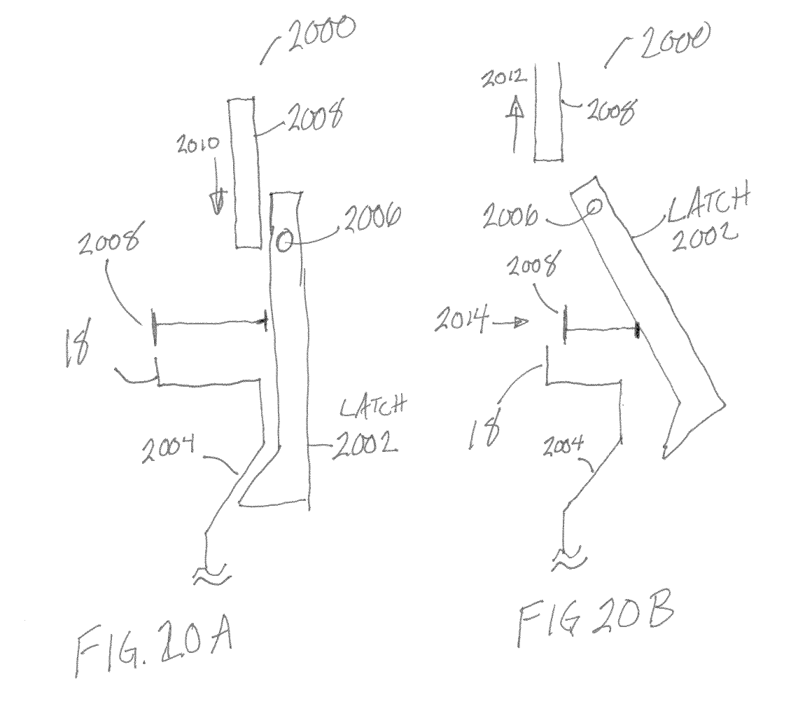

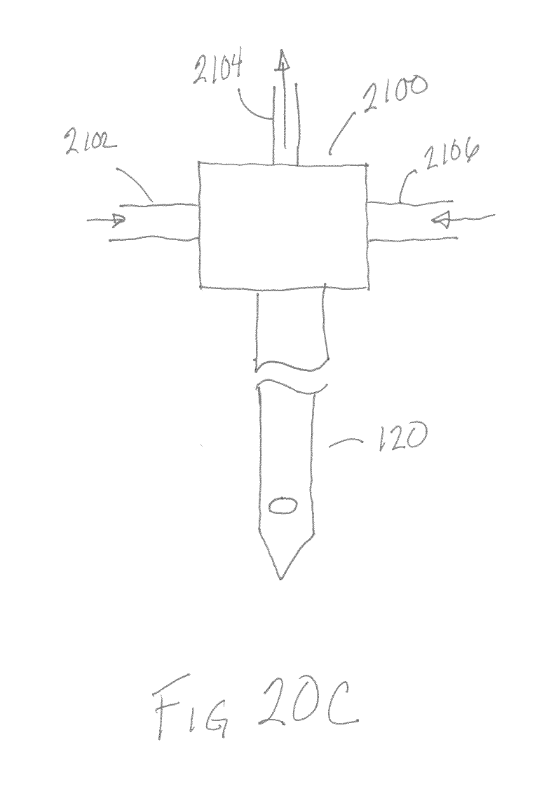

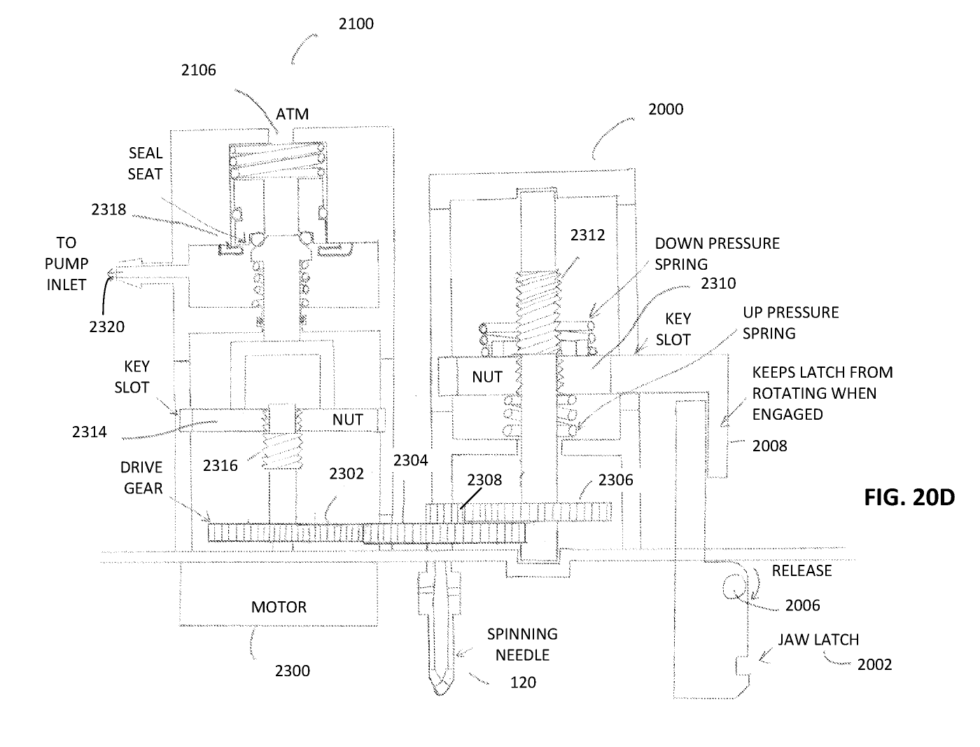

Heated water from the heater tank 16 enters the sensor 90 via the inlet pickup 94 and pushes a float 106 disposed therein upward with continued filling of the heater tank 16 after it is full. In one embodiment (FIG. 9), the float 106 generally has a disk-like shape and floats on top of the water entering the cavity 92. The buoyancy of the float 106 allows it to rise with the water level in the cavity 92 as water exits the heater tank 16 and fills the interior of the sensor 90. The float 106 eventually contacts one or more downwardly-extending legs 108 that prevent the float 106 from completely occluding or sealing the sensor outlet 96. At this point, the float 106 is disposed between the emitter 100 and the photoreceptor 104, thereby occluding the photoreceptor 104 from receiving the light beam 102 from the emitter 100. The sensor 90 may relay a signal to a device such as the microcontroller 50 (FIG. 20) indicating that the heater tank 16 is full because the light beam 102 is no longer being sensed by the photoreceptor 104. The downwardly extending legs 108 preferably include one or more passageways 110 (FIG. 9) therebetween that permit water in the heater tank 16 to bypass the float 106 and flow out through the outlet 96 during the brew cycle. Of course, the heater tank water level sensor 90 can work with the heater tank 16 or separately.

In an alternative embodiment of the present disclosure, the system 10 may include a heater tank water level sensor 90′ having a D-shaped cavity 92′ with a spherical float 106′ disposed therein, as shown in FIG. 10. In this embodiment, a set of projections 112 can selectively horizontally position the float 106′ within the D-shaped cavity 92′ for eventual alignment or positioning between the emitter 100 and the photoreceptor 104 while simultaneously allowing or permitting substantial flow (e.g., laminar flow) of fluid through the cavity 92′ during a brew cycle, and after the heater tank 16 is full. The projections 112 may be formed from a portion of the interior sidewalls of the cavity 92′ and extend inwardly thereof, or the projections 112 may be formed from or extend out from the spherical float 106′ and slide relative to the interior sidewalls of the cavity 92′. In either embodiment, the projections 112 are preferably of a shape and size to minimize disruption of vertical fluid flow through the cavity 92′ and to minimize the vertical surface area contact between the projections 112 and either the spherical float 106′ or the interior sidewalls of the cavity 92′, to allow the spherical float 106′ to vertically move within the cavity 92′.

As mentioned above, the system 10 can pump enough water from the reservoir 14 to fill the heater tank 16 and the inlet pickup 94. At least initially, when no water is in the cavity 92′, the spherical float 106′ resides at or near the bottom thereof. As the pump 12 continues to move water into the now full heater tank 16, the water level rises in the cavity 92′, thereby causing the spherical float 106′ to rise with the water level. As mentioned above, the projections 112 bias the spherical float 106′ so the body of the float 106′ remains in substantially the same general horizontal position shown in FIG. 10. This enables the spherical float 106′ to eventually interrupt transmission of the light beam 102 from the emitter 100 to the photoreceptor 104, thereby signaling that the heater tank 16 is full. The projections 112 basically constrain the horizontal position of the spherical float 106′, while permitting the float 106′ to move vertically as the water level in the cavity 92′ changes. As illustrated in FIG. 10, the float 106′ includes six of the projections 112, but the float 106′ may have more or less of the projections 112 as may be desired or needed. Preferably, the spherical float 106′ occupies only a portion of the D-shaped cavity 92′ so there is sufficient room for fluid to flow around the float 106′ and the projections 112, thereby supplanting any need for the legs 108 or the passageways 110.

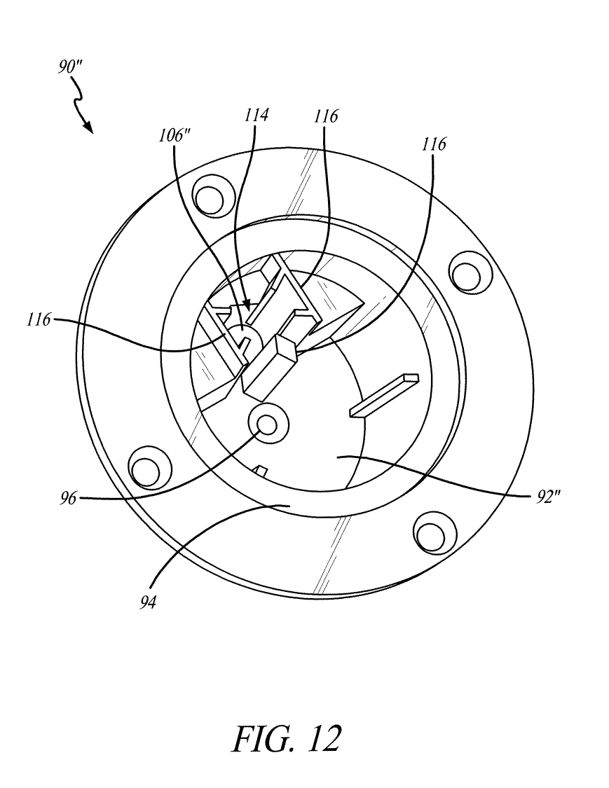

FIGS. 11-13B illustrate another embodiment of a heater tank water level sensor 90″ wherein the cavity is split or partitioned into a first or main cavity 92″ adjacent to a second float cavity 114 that retains a spherical float 106″ therein. One or more cavity walls 116 may define the float cavity 114 next to the cavity 92″ and horizontally confine the float 106″ therein for eventual alignment or positioning between the emitter 100 and the photoreceptor 104 (FIG. 13a) while simultaneously permitting substantial laminar flow of fluid through the cavity 92″ as a result of being offset from the central axis of the sensor outlet 96. That is, the partition walls 116 retain the float 106″ in substantially the same general horizontal position while still permitting the float 106″ to move vertically as the water level in the cavity 92″ changes during a brew cycle. Of course, the partition walls 116 are configured to permit water to flow into and out from the float cavity 114 to raise and lower the float 106″ depending on the water level in the heater tank 16 and/or the heater tank water level sensor 90″. As specifically illustrated in FIG. 11, the float cavity 114 includes three walls 116 offset form the relatively larger cavity 92″. Although, a person of ordinary skill in the art will readily recognize that a different quantity of the walls 116 could be used as long as the float 106″ could operate the sensor 90″ as disclosed herein. Additionally, the cavity 92″ is generally open and somewhat D-shaped as described above with respect to FIG. 10, but a person of ordinary skill in the art will also readily recognize that the cavity 92″ could be any shape known in the art (e.g., rectangular, square, etc.). It is preferred, however, that the central axis aligning the sensor outlet 96 and the inlet pickup 94 (not shown in FIG. 11) be generally free from obstruction to encourage flow, such as laminar flow, of fluid through the heater tank water level sensor 90″. In this respect, FIG. 12 illustrates an alternative view of the size and positioning of the cavity 92″ relative to the float cavity 114 formed by the partition walls 116.

The heater tank water level sensor 90″ operates in generally the same manner as described above with respect to the heater tank water level sensors 90, 90′. As water fills the cavity 92″, the float 106″ rises to the top thereof, thereby occluding the photoreceptor 104 from receiving the light beam 102 emitted by the emitter 100. As shown in FIG. 12, the float 106″ occupies a relatively small portion of the sensor 90″ relative to the partitioned cavity 92″ and is offset or otherwise disposed horizontally away from the sensor outlet 96 (i.e., not coaxial), thereby providing an unobstructed path between the inlet pickup 94 and the sensor outlet 96.

FIGS. 13A and 13B illustrate the general outer structural housing of the heater tank water level sensor 90″. In this respect, the sensor 90″ attaches to the top of the heater tank 16 (FIG. 13B) by way of, for example, a series of screws 130, and below a T-shaped conduit 117 that separates out into a third conduit 118 and an air line 124. Here, the heater tank water level sensor 90″ is separated from the T-shaped conduit 117 (and by extension the third conduit 118 and the air line 124) by the sensor outlet 96. As shown best in FIGS. 13A and 13B, the float portion 114 is offset from the cavity 92″ and terminates at a first height A, which is below the upper termination height B of the cavity 92″. As a result, a sensor circuit 119 (FIG. 13A) detects a water level in the sensor 90″ at height A, a level below the fill level B of the cavity 92″.

Accordingly, an air gap or air blanket may exist between height A and termination height B, which is below the T-shaped conduit 117 and the corresponding third conduit 118 and the air line 124. In this embodiment, the heater tank water level sensor 90″ is able to determine that the heater tank 16 is full before the water level therein fills the cavity 92″ (e.g., below fill point B), and certainly before water enters the T-shaped conduit 117 or either of the third conduit 118 or the air line 124.

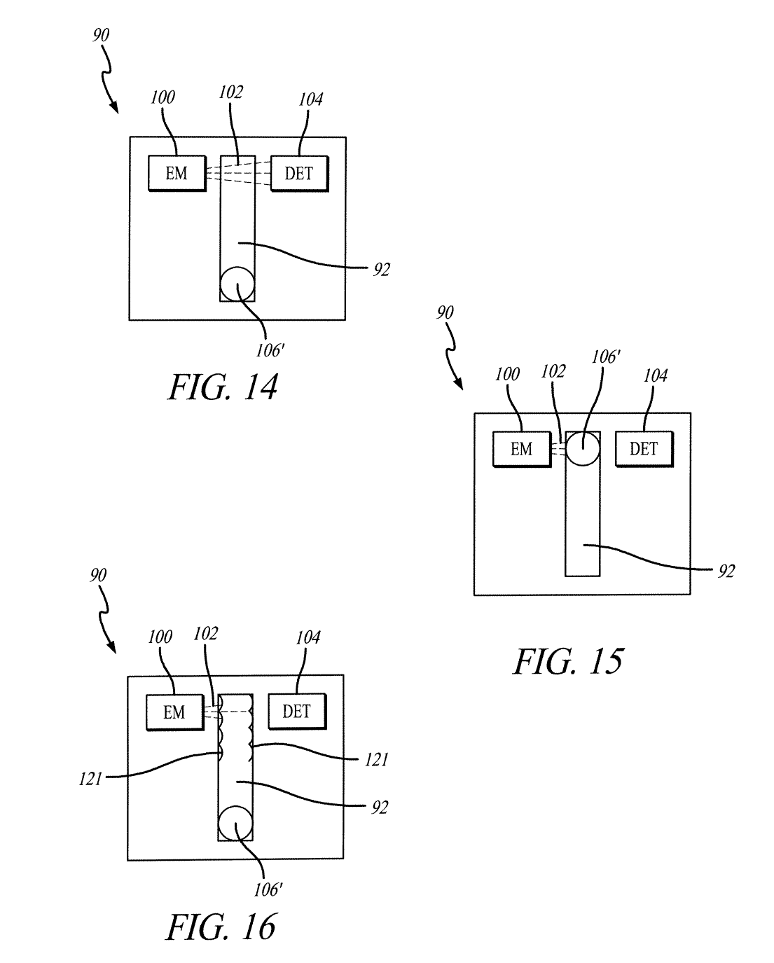

As illustrated in FIG. 16, condensation may cause the heater tank water level sensors 90, 90′, 90″ to send false readings to the microcontroller 50 indicating that the heater tank 16 is full. As discussed in greater detail above, the sensor 90 includes the emitter 100 that emits the light beam 102 across the cavity 92 for reception by the photoreceptor 104. When the heater tank 16 is not full as illustrated in FIG. 14, the photoreceptor 104 receives the light beam 102. Conversely, the float 106′ occludes the light beam 102 when heater tank 16 is full, as shown in FIG. 15. During a brew cycle, the water in the heater tank 16 and in the heater tank sensor 90 is preferably at a desired brew temperature (e.g., close to the boiling temperature of water, i.e., 192° Fahrenheit, for coffee). When this water cools, e.g., during energy saver mode, steam or moisture in the air may condense on the inner walls of the cavity 92 in the form of droplets or bubbles 121 show in FIG. 16. These droplets or bubbles 121 form various concave and convex light refracting surfaces on the walls of the cavity 92. This can cause the light beam 102 to diverge into multiple directions, thereby significantly decreasing the intensity that would otherwise be received by the photoreceptor 104. In this respect, the droplets or bubbles 121 on the walls of the cavity 92 basically cause the rays in the light beam 102 to scatter. As such, significant condensation may scatter the light beam 102 to an extent that the photoreceptor 104 no longer reads the beam 102 even though the heater tank 16 is not completely full. To this end, the controller 50 may incorrectly identify the heater tank 16 as being full. A false heater tank sensor reading can prevent the system 10 from brewing or brewing the desired serving size.

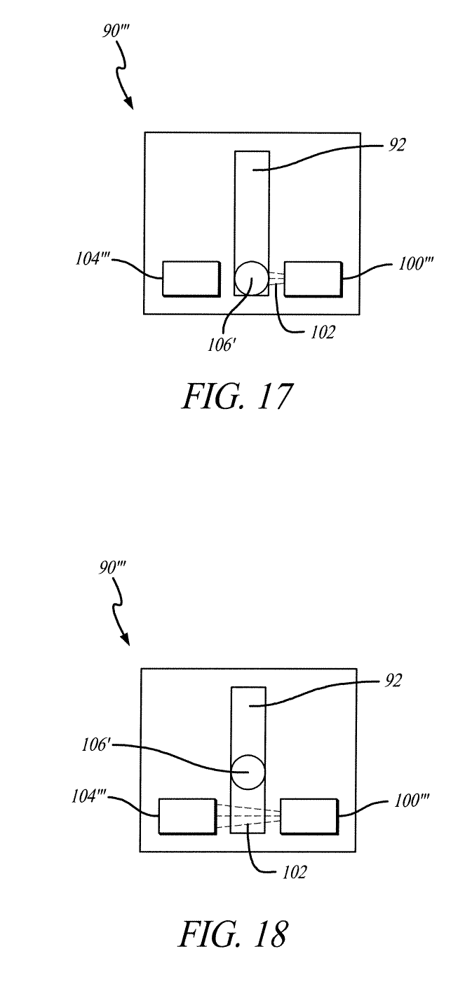

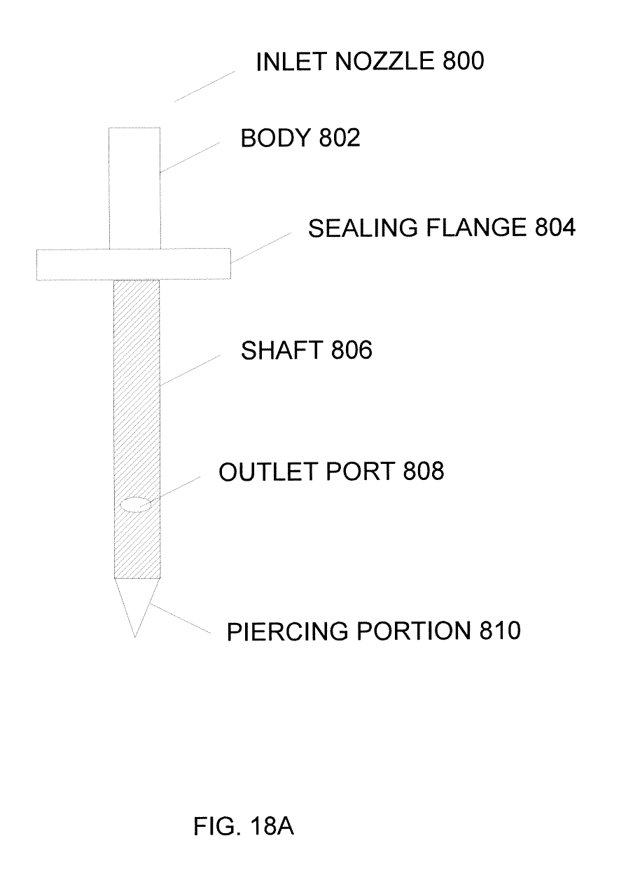

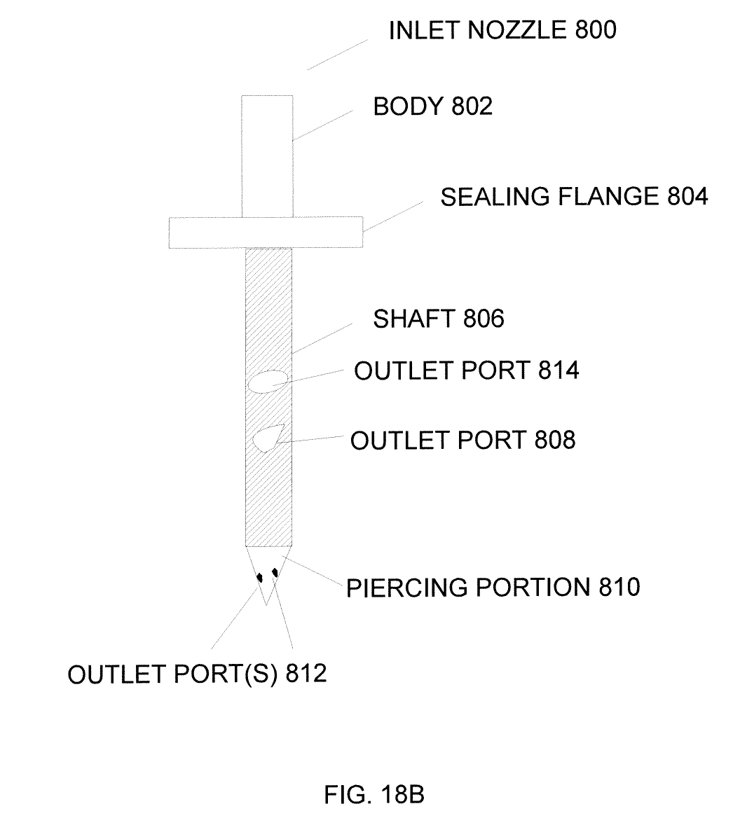

As such, in an alternate embodiment illustrated in FIGS. 17 and 18, a heater tank water level sensor 90′″ includes an emitter 100′″ and a photoreceptor 104′″ disposed at the bottom of the heater tank water level sensor 90′″. In this respect, the float 106′ occludes the photoreceptor 104′″ from receiving the light beam 102 when the heater tank 16 is not full, as shown in FIG. 17. Here, the float 106′ is at the bottom of the cavity 92 when the heater tank 16 is not full. The float 106′ is eventually pushed out of occlusion with the light beam 102 when the water level in the sensor 90′″ surpasses the level of the emitter 100′″ and the photoreceptor 104′″, as illustrated in FIG. 18. As such, the microcontroller 50 knows that the heater tank 16 is full when the photoreceptor 104′″ receives the light beam 102.

In this embodiment, the sensor 90′″ is not affected by condensation, as the sensors 90, 90′, 90″ could be. Here, when the cavity 92 is empty (i.e., a condition when condensation may exist in the cavity 92), the float 106′ is in a position to occlude transmission of the light beam 102 between the emitter 100′″ and the photoreceptor 104′″. In other words, occlusion in this embodiment indicates the heater tank 16 is not full. Thus, even if condensation exists in the cavity 92, causing the light beam 102 to scatter as described above, it does not matter because the float 106′ is designed to occlude transmission of the light beam 102 anyway. When the cavity 92 is full, the float 106′ moves out from within a position occluding transmission of the light beam 102. As shown in FIG. 18, the light beam 102 resumes transmission between the emitter 100′″ and the photoreceptor 104′″ through the water filled cavity 92. Notably, water within the cavity 92 does not affect the sensor readings. It is not the water itself that causes the divergence in the light beam 102, but instead the concave and convex surfaces of the water droplets or bubbles 121 on the walls of the cavity 92 formed by the surface tension of water, which can cause the light beam 102 to disperse or scatter. When the heater tank 16 is full, there are no water droplets on these surfaces, as shown in FIG. 18. As such, the light beam 102 passes through the water without any significant divergence thereof that would result in false readings.

The heater tank sensors 90, 90′, 90″, 90′″ can act as a binary switch to turn the pump 12 “on” and/or “off” depending on the fill state of the heater tank 16. Accordingly, the photoreceptor 104, 104′″ is either in a state where it is receiving or sensing the light beam 102 from the emitter 100, 100′″, or the photoreceptor 104, 104′″ is not receiving or sensing the light beam 102. In this respect, the sensors 90, 90′, 90″, 90′″ do not sample the degree or level of occlusion. Rather, the sensors 90, 90′, 90″, 90′″ operate more akin to a light switch with distinct “on” and “off” conditions which indicate whether the heater tank is full or not full.

Fluid Flow from Heater Tank

The beverage brewing system 10 further includes the brew head 18 having the brew chamber 20 that holds the brew cartridge 22 containing a sufficient amount of the beverage medium 24, such as coffee grounds, to brew a predetermined amount of a beverage, such as coffee (e.g., 10 ounces), during a brew cycle. The third conduit 118 couples the heater tank sensor outlet 96 to the brew head 18 so the pump 12 can displace heated water from the heater tank 16 through the third conduit 118 and into the brew cartridge 22. Preferably, the system 10 includes a rotating inlet needle 120 that pierces the brew cartridge 22 and injects hot water and steam into the beverage medium 24 therein. The rotating inlet needle 120 may be any of those disclosed in PCT Appl. No. PCT/US15/15971, the contents of which are incorporated by reference herein in their entirety.

A brew head check valve 122 (FIGS. 1, 7 and 19), which preferably has the same or similar specifications as the first and second check valves 46, 88, can be disposed between the sensor outlet 96 and the rotating inlet needle 120 in series along the third conduit 118. The brew head check valve 122 is preferably a one-way check valve also having a positive cracking pressure (e.g., 2 psi). In this respect, the brew head check valve 122 can prevent liquid from flowing to the brew head 18 unless the flow reaches the cracking pressure (e.g., 2 psi).

The brew head check valve 122 also helps prevent the brew head 18 from dripping after the brew cycle is complete because the residual water within the third conduit 118 and behind the brew head check valve 122 is under insufficient pressure to open the brew head check valve 122. Of course, the brew head check valve 122 may have different specifications than the first and second check valves 46, 88, including a different cracking pressure.

Moreover, the third conduit 118 may be configured to drain residual water back into the heater tank 16 (e.g., by gravity, such as by positioning the third conduit 118 above the heater tank 16). Furthermore, a portion of the third conduit 118 may be shaped into a drain catch or trap to help prevent water backflow. Preferably, the brewing system 10 removes as much residual water from the third conduit 118 as possible so only heated water from the heater tank 16 is injected into the brew cartridge 22 at the start of the next brew cycle. As such, the beverage brewing system 10 disclosed herein is advantageous over conventional systems that permit residual water to remain in the third conduit 118 between the heater tank 16 and the brew head 18 at the end of the brew cycle.

To pump air at the end of the brew cycle, the beverage brewing system 10 further includes an air line 124 (e.g., FIGS. 1 and 19) open to atmosphere and fluidly coupled to the first conduit 40 behind the pump 12 and in front of the flow meter 48 (if included). The open end of the air line 124 may be disposed over the reservoir 14 as illustrated in FIGS. 1, 7, and 19 so any backflow of water in the system 10 drips or drains back into the water reservoir 14. A first solenoid valve 126 may be placed in series with the air line 124 to control access to the atmospheric air. Initially, when the pump 12 displaces water from the reservoir 14 to the heater tank 16, the first solenoid valve 126 is closed. To pump air, the first solenoid valve 126 opens so the first conduit 40 opens to atmosphere. In the embodiment shown in FIG. 1, when the air pressure in the first conduit 40 equalizes with the atmosphere, which is lower than the pressure within the first conduit 40 when the solenoid valve 126 was closed, the pressure in front of the first check valve 46 drops to atmosphere and below the cracking pressure, thereby allowing the first check valve 46 to close. Accordingly, the pump 12 stops displacing water and, instead, starts pumping air from the air line 124 exposed to atmosphere. As such, water no longer flows to the pump 12 from the reservoir 14. Conversely, if the first solenoid valve 126 closes, the pump 12 will re-pressurize the first conduit 40 and begin displacing water from the reservoir 14. In this respect, the first solenoid valve 126 can effectively control the pumping medium (i.e., air or water).

The beverage brewing system 10 also includes a vent 128 for controlling the pressure in the third conduit 118. In one embodiment as shown in FIG. 8, the vent 128 splits off from the third conduit 118 between the brew head check valve 122 and the sensor outlet 96 as shown in FIGS. 1, 7, and 19. In one embodiment (shown in FIGS. 13A and 13B), the sensor outlet 96 may couple to the Y- or T-shaped conduit 117. That is, one side of the Y- or T-shaped conduit 117 facilitates connection with the vent 128 and the other side of the Y- or T-shaped conduit 117 facilitates connection with the third conduit 118. Preferably, the open end of the vent 128 is disposed over the reservoir 14, as illustrated in FIGS. 1, 7, and 19, to drip or drain water back to the reservoir 14 (if needed), similar to that described above with respect to the air line 124. In this respect, the vent 128 may optionally include an overflow fitting (not shown) to facilitate connection with the reservoir 14. The vent 128 may also include a second solenoid valve 132 that opens the third conduit 118 to atmosphere when “open” and closes off the third conduit 118 from the atmosphere when “closed”. The second solenoid valve 132, in one embodiment, closes upon or near a brew cycle beginning. When the second solenoid valve 132 is “open”, pressure on the outlet side of the heater tank 16 equalizes with the atmosphere and the pressure in the third conduit 118 falls to atmosphere. This pressure drop allows the brew head check valve 122 to close by reducing the pressure in the third conduit 118 to below its cracking pressure. Thus, opening the second solenoid 132 helps prevent unwanted dripping at the end of the brew cycle because the third conduit 118 is closed off from further fluid flow by virtue of closing the brew head check valve 122.

### Liquid Disbursement and Nozzle Movement

In an aspect of the present disclosure as shown in FIG. 18A, an inlet nozzle 800 may be employed. The inlet nozzle 800 may comprise a body 802, a seal flange 804, a shaft 806, one or more outlet ports 808, and a piercing portion 810. The inlet nozzle 800 may have a round cross-section, although the inlet nozzle 800 may also have a different cross-sectional shape. Further, the inlet nozzle 800 may have different cross-sectional shapes within the different portions 802-810 as desired.

The inlet nozzle 800 may have a shaft 806 that is coaxial with a centerline of the inlet nozzle 800 as shown in FIG. 18A. However, in other aspects of the present disclosure, the shaft 806 may be misaligned with the centerline of the inlet nozzle 800, such as laterally misaligned, rotationally misaligned, both, or another form or combination of forms of misalignment. Further, any portion 802-810 of the inlet nozzle 800 may have coaxial or other alignment relationships with respect to any other portion 802-810 of the inlet nozzle 800.

The body 802 may be hollow, or may have some other mechanism to deliver water from the heater tank to the outlet port(s) 808. Further, the body portion may have other features that allow the body 802 to perform other functions, or may be shaped for ease of construction of the brewing system 10. The inlet nozzle 800 may also be replaceable or interchangeable with other inlet nozzles 800 as part of an upgrade to the brewing system 10, and further, the brewing system 10 may have multiple inlet nozzles 800 for use with various brewing materials 32 based on a user selection of a brewing material 32 and/or a code, marking, or other indicia on the brew cup 120 that is detected by the brewing system 10. The microcontroller (processor) 50 may select one or more inlet nozzles 800 for use with a given brew cup 24.

The seal flange 804 may comprise a different material than the remainder of the material used to manufacture inlet nozzle 800. Further, the seal flange 804 may have an o-ring or other sealing mechanism to provide a water-tight and/or air-tight seal when the inlet nozzle is placed in mechanical contact with the brew cup 24. The seal flange 804 provides a seal such that water from the heater tank is directed toward the brewing material 32 and does not leak out of the brew head 44.

The shaft 806 may be situated to extend into the brew cup 24 and the associated brewing material 32 to a desired depth. Different brewing materials 32 may use different length shafts 806 to obtain improved brewing and/or flavor extraction from a given brewing material 32. Further, the shaft 806, although shown as essentially cylindrical in FIG. 18A, may have rifling, grooves, or other surface treatments to assist with brewing in the brewing system 10.

The outlet port(s) 808 provide an opening for water delivered from the heating tank to be dispensed into the brew cup 24 and mix with the brewing material 32. Depending on the brewing material 32, water temperature, water softness or hardness, pressure in the overall brewing system 10, and/or other factors, the shape and/or quantity of the outlet port(s) 808 may vary. For example, and not by way of limitation, the outlet port 808 shown in FIG. 18A may be oval, in which the major axis can be substantially perpendicular to the axis of the inlet nozzle 800. However, as shown in FIG. 18B, the outlet port 808 is teardrop shaped, with the major axis of the teardrop being at an angle approximately 45 degrees away from the axis of the inlet nozzle 800. The present disclosure envisions any number and/or shapes for the outlet port(s) 806 in the inlet nozzle 800, where the number and shapes of the outlet ports can vary based on, again, the temperature of the water, the particular beverage medium 32 being used, the rotational, oscillation, nutation, and/or other movements of the inlet nozzle 800 during a brew cycle where the inlet nozzle 800 is used.

Further, the outlet ports 806 in a given inlet nozzle 800 may be individually activated based on the brewing material 32, where each of the outlet ports 806, just as the rotational, oscillatory, or other movement of the inlet nozzle 800 is controlled by microcontroller 50. For example, and not by way of limitation, an inlet nozzle 800 as shown in FIG. 18B may have four (or any other number) of separate outlet ports. Outlet port 808 is teardrop shaped. Outlet ports 812 may be located in the piercing portion 810 of the inlet nozzle 800 and may be circular or oval in shape. Outlet port 814 may be oval in shape. During a first part of a brew cycle, outlet ports 812 may be opened, through a plunger or other mechanism internal or external to the inlet nozzle 800, to, for example pre-wet the beverage material 32. The time that the outlet ports 812 are active, and the movement of inlet nozzle 800, including the type, time, and speed of movement of the inlet nozzle may be controlled based on a number of factors, e.g., water temperature, pressure in the system 10, beverage medium 32, or other variables.

During a second part of a brew cycle, outlet ports 812 may be closed, and outlet port 814 may be opened, again, through a mechanism internal or external to the inlet nozzle 800, to perform a first brewing of the brewing material. For example, a high pressure blast of higher temperature water, or a different liquid or material altogether, may be desired for certain brewing materials 32 to rapidly remove or add flavors from/to the brewing material. The shape and usage of one or more outlet ports 808, 812-814 may allow different types of mixtures of water, other materials, and/or brewing processes to be performed by a single brewing system 10.

A third outlet port 808 may be used in a third part of a brew cycle, or some of the outlet ports may remain unused during a brew cycle depending on the brewing material 32 and/or other factors.

### Multiple Nozzles

FIG. 19A illustrates another embodiment of an inlet nozzle of the present disclosure. Inlet nozzle 900 may comprise an outer nozzle 902 and an inner nozzle 904. Outer nozzle 902 and inner nozzle 904 may move independently of each other, i.e., outer nozzle 902 may move while inner nozzle 904 remains stationary, outer nozzle 902 may oscillate while inner nozzle 904 rotates in one or more directions, etc. Any combination of movement or stationary positioning for either and/or both outer nozzle 902 and inner nozzle 904 is possible within the scope of the present disclosure.

As shown in the cutaway view of FIG. 19A, outer nozzle 902 and inner nozzle 904 are in contact at seal 906. As such, inner nozzle 902 may be extended further into the brewing material 32 during a brew cycle as desired. Further, inner nozzle 904 may be spring loaded or otherwise pressure fit against outer nozzle 902, such that pressure from liquid 908 may extend inner nozzle 904 into the brewing material 32.

Further, liquid 910, which may be the same material as liquid 908 or a different material, may travel inside a hollow portion of inner nozzle 904 or be elsewise fed to one or more outlet ports 912. This disbursement of liquid 910 may be used during one or more time periods of a brew cycle as described with respect to FIGS. 18A and 18B. The outlet port(s) 912 may take any shape and be individually controlled as described with respect to FIGS. 18A and 18B. For example, and not by way of limitation, outer nozzle 902 may have an internal passage way that allows one fluid to flow within outer nozzle 902 and a second fluid may flow between the inner nozzle 904 and the outer nozzle 902.

Similarly, outlet ports 914 and 916 may also inject liquid 908 into the brewing material 32 during one or more portions of a brew cycle. Outlet ports 914 and 916 may have similar or different sizes and/or shapes as described with respect to FIGS. 18A and 18B. Further, outlet ports 914 and 916 may be at different depths along the length of the outer nozzle 902, allowing for liquid 908 to be dispensed at different depths, rates, and/or pressures into the beverage material 32.

Another embodiment of the present disclosure is shown in cutaway view in FIG. 19B. Again, inner nozzle 904 may move with respect to outer nozzle 902, although both outer nozzle 902 and inner nozzle 904 may be moving at the same time in an aspect of the present disclosure. As an example, and for ease of understanding, the outer nozzle 902 may remain stationary and the inner nozzle 904 may rotate during at least some portion of a brew cycle.

During this portion of the brew cycle, and within inner nozzle 904, outlet ports 918 and 920 can allow liquid 910 to be emitted from inner nozzle 904. As inner nozzle 904 rotates, outlet port 920 will, at some point in the rotation, align with outlet port 914 of outer nozzle 904, and the pressure of the liquid 910 will force the liquid 910 out of outlet port 914 and into the beverage material 32. Similarly, at some point in the rotation, outlet port 918 will align with outlet port 916 and the pressure exerted on liquid 910 will force liquid 910 out of outlet port 916 and into the beverage material 32.

Further, outer nozzle 902 may move up and down with respect to inner nozzle 904 to block and/or open one or more of the outlet ports 918 and 920 at various times during the brew cycle. For example, and not by way of limitation, during one portion of a brew cycle, outer nozzle 902 may block outlet port 918, while outlet port 920 is open to inject fluid into the brew container 22. During another portion of the brew cycle, outer nozzle may move to block outlet port 920 and open outlet port 918. Permutations and combinations of opening, blocking or closing, and various movements of the inner nozzle 904 and outer nozzle 902 are envisioned as within the scope of the present disclosure.

The embodiments of the present disclosure shown in FIGS. 18A, 18B, 19A, and 19B are merely examples of inlet nozzles that may be employed within the scope of the present disclosure. Any combination or permutation of motion, outlet port size, outlet port shape, inner and outer nozzles, multiple inlet nozzles, tertiary or quaternary or other multiples of inner and outer nozzles, or other variations of inlet nozzle design or materials to improve beverage material 32 mixing with fluid and/or improved beverage material 32 brewing characteristics are envisioned as being within the scope of the present disclosure.

### Coupling Vent and Check Valves

In another embodiment of the present disclosure as shown in FIG. 8A, the system 10 may have a single component 1000 that comprises the functionality of the vent valve 132 and the check valve 122. As such, the heater tank 16 outlet 96 provides water or other pressurized fluid (e.g., steam, etc.) from the heater tank 96 to an inlet port as shown in FIGS. 8C and 8D. Depending on the pressure differential between the inlet port and the outlet port coupled to the brewing container 120, the valve 1000 will either deliver water (and/or air, steam, etc.) to the brewing container 120 or deliver water (and/or air, steam, etc.) back to the water tank 14.

In FIG. 8B-8D, cutaway and exploded view of a vent valve coupled to a check valve is illustrated in an aspect of the present disclosure.

Referring to the fluid flow diagram of FIG. 8A and the views of FIGS. 8B-8D, the vent valve portion of the component 1000 (coupled to the reservoir 14) is biased open and the check valve portion is biased closed when there is insufficient pressure from the heater tank 16 to open the check valve portion (i.e., at the inlet port of component 1000). As such, before the biasing of the component 1000 is overcome by pressure at the inlet port, residual gasses and liquid will flow from the heater tank 16 back to the reservoir 14.

Once the pressure increases at the inlet port of the component 1000, the surface area of the check valve receives more force than the vent valve (due to the check valve's larger area), and the bias of a closed position for the check valve is overcome. In an aspect of the present disclosure, the needle of the vent valve is coupled, either rigidly or with variable force such as a spring, to the piston of the check valve, such that as the pressure from the inlet port is increased, the vent valve closes and the check valve opens as shown in FIG. 8D. The vent valve portion and the check valve portion of the component 1000 can both be open, or one can be open when the other is closed, depending on the overall design desires and requirements of system 10.

Certain situations may cause backpressure from the container 22 on the check valve portion of component 1000. For example, and not by way of limitation, a brewing container 120 may become clogged or experience poor fluid flow thus causing a backup of fluid. This backpressure changes the pressure differential across the check valve portion of component 1000, and this change in pressure differential can cause the check valve portion of component 1000 to close.

However, for safety and other reasons, because the check valve portion and the vent valve portion of component 1000 are coupled together within component 1000, the pressure that is still present from the heater tank will be vented through the vent valve portion of component 1000 back to the reservoir 14. Further, should such a condition occur that is unexpected, as the vent valve and check valve operation of component 1000 may be monitored or otherwise sensed by the microcontroller 50 during brewing or other operations of system 10, an error condition or emergency procedure may be undertaken by microcontroller 50 to reduce hazardous conditions that a consumer or user might be exposed to.

FIG. 8B illustrates an exploded view of a possible embodiment of the component 1000 in accordance with an aspect of the present disclosure. Part types and/or numbers are called out in FIG. 8B and listed therein. However, any combination of valves, as well as any combination of biasing, coupling of the valves, or any other equivalents or modifications may be made to the component 1000 without departing from the scope of the present disclosure.

In a further embodiment illustrated in FIG. 19, the vent 128 in the system 10″ includes a path 134 to help prevent water from flowing out of the open end of the vent 128. More specifically, the path 134 is filled with air when the second solenoid valve 132 is closed. When the second solenoid valve 132 opens, residual water from the third conduit 118 may flow into the vent 128 due to the concomitant pressure release associated therewith. As such, some of the air in the tortuous path 134 is displaced by the water flowing in from the third conduit 118. In one embodiment, the length and pressure drop across this path 134 (i.e., the tortuous nature) may ensure that no water is expelled from the open end of the vent 128 (e.g., above the reservoir 14). In this respect, the tortuous path 134 helps ensure that only air exits the open end of the vent 128. The tortuous path 134 may have any shape known in the art such as a spiral, zig-zag, circular, or rectangular path.

In another aspect of the beverage brewing systems disclosed herein, and as specifically shown with respect to systems 10′, 10″ in FIGS. 7 and 19, the first check valve 46 and the second check valve 88 may be omitted. In essence, the pump 12 can be used in place of the second check valve 88 to prevent water from flowing back from the heater tank 16 to the reservoir 14. The pump 12 can operate to force or displace water forward from the reservoir 14 and into the heater tank 16 and, therefore, can act as a one-way valve. In operation, the pump 12 can draw water into an open chamber exposed to the fluid in the first conduit 40. The pump 12 can pressurize the fluid in the chamber and causes forward displacement through the pump cycle. When the pump 12 stops, the diaphragms can block the passageway in the pump 12 from the pump outlet 44 to the pump inlet 42, effectively operating as a check valve. This, of course, prevents reverse flow of water from the second conduit 86 back into the first conduit 40 and toward the reservoir 14. To this end, the second check valve 88 is unneeded to stop backflow of water. The pump 12 is preferably capable of withstanding relatively high temperatures, such as those in the heater tank 16 should heated water from the heater tank 16 backflow to the pump 12.

### Purge Operation

Additionally, in the embodiment illustrated in FIG. 7, the pump 12 displaces water from the reservoir 14 only while water is present in the reservoir 14. Once the reservoir 14 empties, the system 10′ initiates the air purge step (described in detail below). Since no water is available in the reservoir 14 when the air purge begins, there is no need to prevent water from flowing out of the reservoir 14 during this step (i.e., by the positive cracking pressure of the first check valve 46). Thus, it may be possible and desirable to eliminate the first check valve 46 as shown in FIG. 1, since the air purge cycle may initiate when the water reservoir 14 is empty.

Furthermore, with respect to the embodiment illustrated in FIG. 19, the use of the reservoir pickup 34 requires that the pump 12 generate enough force within the first conduit 40 in front of the water reservoir 14 to draw water up into the first conduit 40. This necessarily requires overcoming gravity. When the first solenoid valve 126 opens, pressure within the first conduit 40 drops to atmosphere. As a result of this pressure drop, the pump 12 is no longer able to effectively draw water from the reservoir 14 by way of the pickup 34. As a result, the pump 12 switches from pumping water to pumping air. The change in pumping medium occurs because it is easier for the pump 12 to displace atmospheric air from the open air line 124 than it is to pump water from the reservoir 14 against the force of gravity. In this respect, the first check valve 46 is unnecessary and may be removed to reduce cost and complexity.

In view of the foregoing description, a person of ordinary skill in the art will realize that each of the brewing systems 10, 10′, 10″ may include various combinations of the check valves 46, 88, including using the first and second check valves 46, 88, using only the first check valve 46, using only the second check valve 88, or omitting both the first and second check valves 46, 88 (FIGS. 7 and 19), in accordance with the embodiments disclosed herein. In one specific embodiment, only a single check valve within a pump such as the pump 12 is utilized.

As illustrated in FIG. 20, the system 10 can further include at least one microcontroller 50 for controlling different features of the brewer before, during and after a brew cycle. The microcontroller 50 can be linked to a control panel 136. In one embodiment, the microcontroller 50 may be coupled with the pump 12 and have the ability to turn the pump 12 “on” or “off” in response to the fill state of the heater tank 16 or the quantity of liquid pumped (to satisfy the desired serving size) during a brew cycle. In one embodiment, the microcontroller 50 may receive feedback responses from the sensor 90 (or the photoreceptor 104) and operate the pump 12 based on those feedback responses. For example, in one embodiment when the photoreceptor 104 provides light-receiving feedback (FIGS. 14-15), the microcontroller 50 can know the heater tank 16 is not full. As such, the microcontroller 50 may continue to run the pump 12 to fill the heater tank 16. Conversely, occlusion of the light beam 102 by the float 106′ (FIG. 15) may result in the photoreceptor 104 providing negative feedback to the microcontroller 50. Here, the microcontroller 50 can know the heater tank 16 is full since the float 106′ (FIG. 15) occludes transmission of the light beam 102 to the photoreceptor 104 within the heater tank water level sensor 90.

Conversely, with respect to the embodiments disclosed with respect to FIGS. 17-18, the occlusion of the light beam 102 by the float 106′ may cause the sensor 90′″ to send feedback to the controller 50 that the heater tank 16 is not full. Once the heater tank 16 is full and additional water enters the cavity 92, as described in detail above, the float 106′ moves out into a non-occluding position wherein the light beam 102 can be received by the photoreceptor 104′″ as shown in FIG. 18. Here, the sensor 90′″ may provide positive feedback to the microcontroller 50 that the light beam 102 is being received by the photoreceptor 104′″ to signal that the heater tank 16 is full. Once it is determined that the heater tank 16 is full, the microcontroller 50 may shut “off” the pump 12.

One skilled in the art will understand that the system 10 may include one or more of the microcontrollers 50, and that the microcontroller(s) 50 can be used to control various features of the system 10 beyond simply turning the pump “on” or “off”. For example, the microcontroller 50 may also control, receive feedback from, or otherwise communicate with the heater tank temperature sensor 84 (e.g., to monitor heater tank water temperature), the water level sensor 38 in the reservoir 14 (e.g., determine if there is any water to brew), the flow meter 48 (e.g., monitoring the quantity of water pumped to the heater tank during a brew cycle), the heating element 82 (e.g., regulate water temperature in the heater tank 16), heater tank water level sensor 90 (e.g., determine fill state of the heater tank 16), the emitter 100 (e.g., to turn “on” or “off” the light beam 102), the photoreceptor 104 (e.g., to determine occlusion of the light beam 102), the rotating inlet needle 120 (e.g., activation and rotation during a brew cycle), the first solenoid valve 126 (e.g., open or close), and/or the second solenoid valve 132 (e.g., open or close).

As shown in FIGS. 20A and 20B, a latching mechanism 2000 may be coupled to the brew head 18 to allow for insertion and removal of the beverage medium 24 into the brew chamber 20. There are appropriate times for insertion and removal of the beverage medium 24, e.g., a single-serving cup in the brew head 18. Once a brew cycle is finished, the single-serve cup is often removed from the brew head 18, and a new single-serve cup with new beverage medium 24 may be inserted to have a new brew cycle begin. However, during a brew cycle, heated fluid from the heater tank 16 is flowing into and out of the brew head 18, and as such, the brew chamber may need to be inaccessible for safety and consistency reasons. For example, and not by way of limitation, if the brew head 18 is opened during a brew cycle when heated liquid is flowing, a consumer or user may be exposed to the heated fluid from the heater tank 16, which may be a safety hazard. Such events may not be desirable operating modes for the system 10.

As such, a latching mechanism 2000 may be employed to prevent opening of the brew head 18 at specific times during a brew cycle. In the embodiment shown, a latch 2002 and a plate or other recess 2004 are in close proximity when the brew head 18 is in a closed position. The latch 2002 pivots about a pivot point 2006, and a button or other mechanical or electrical device 2008 may be selectively coupled to the latch 2002. The device 2008 may also be coupled to the recess 2004, or other mechanical, electrical, or other types of mechanisms 2000 may be employed within the scope of the present disclosure to close the brew head 18. Further, although described herein as a pivoting motion, any type of motion of latch 2002 is envisioned as being within the scope of the present disclosure.

A stop 2008 may also be positioned near the latch 2002. The stop 2008 can be positioned in one or more positions to selectively prevent the latch 2002 from being disengaged from the recess 2004. As shown in FIG. 20A, if the button 2008 is pressed toward latch 2002, the stop 2008, which is in a “locked” position 2010, substantially prevents the latch 2002 from pivoting about pivot 2006, and thus latch 2002 remains coupled to recess 2004. Brew head 18 cannot be opened when the latch 2002 cannot pivot about pivot 2006.

However, when the stop 2008 is in the “unlocked” position 2012, the stop 2008 does not substantially interfere with the latch 2002 pivoting about pivot 2006, and thus, when button 2008 is pressed as shown by arrow 2014, the button 2008 engages the latch 2002 and pivots latch 2002 about pivot 2006. This disengages latch 2002 and enables the brew head 18 to be opened such that access to the brew chamber 20 is accomplished.

Although shown in an “on/off” or “locked/unlocked” state, there is a point where stop 2008 either engages latch 2002 or disengages with latch 2002 such that latch 2002 may be moved about pivot point 2006. Once this point is reached, the latch 2002 is either locked or unlocked, and further motion of the stop 2008 does not add to or detract from the ability of latch 2002 to move.

In aspects of the present disclosure, the latch 2002 and/or stop 2008 may be coupled to a solenoid controlled by microcontroller 50 or other similar device. Further, stop 2008 may be mechanically controlled by other means, e.g., the shafts of a motor coupled to needle 120, either directly or with gears, or to other devices within system 10 to move stop 2008 to a locked and/or unlocked position as desired. Movement of stop 2008 may be in any direction, e.g., up and down as shown in FIGS. 20A and 20B, in the direction of the pivot 2006, or in any manner such that stop 2008 will selectively allow the movement of latch 2002 from a locked to an unlocked position when the locking and/or unlocking of the brew head 18 is desired.

In another aspect of the present disclosure, the stop 2008 may also be controlled by other mechanical aspects of the system 10. For example, and not by way of limitation, the stop 2008 may be moved from a locked to an unlocked position when the check valve 122 (or component 1000) is closed. When check valve 122 (or component 1000) is closed, no fluid is being delivered from heater tank 16 to brew head 18, and as such, it may be a safe condition to allow opening of the brew head 18. Further, when check valve 122 (or component 1000) is open, the movement of the check valve 122 (or component 1000) may be the activating motion to lock the brew head 18, as the system 10 is delivering heated fluid to the brew head 18 from the heater tank 16 during such a condition of the check valve 122 (or component 1000).

FIG. 20C illustrates a purge mechanism in accordance with an aspect of the present disclosure.

When a brew cycle is completed, needle 120 may be removed from container 24 or the rotation of the needle 120 may stop. Either through control from microcontroller 50, or through other mechanical means, a flow through purge device 2100 of fluid from inlet 2102 to outlet 2104 must be directed from air inlet 2106 of purge device 2100. This may be accomplished by selectively coupling pump 12 to a source of air and selectively coupling pump to purge inlet 2106, and this selective coupling may be performed by valves and/or switches controlled by microcontroller 50.

Further, in another aspect of the present disclosure, the selective coupling of pump 12 to purge inlet 26 may be controlled by mechanical means that are selectively engaged during known periods of the brew cycle. For example, and not by way of limitation, as stop 2008 is being moved from a locked to an unlocked position, a mechanical device, such as a threaded rod or other linear or rotational motion of a device, including but not limited to the movement of check valve 118 (or component 1000), may be employed to move stop 2008 in a given direction. The threaded rod or other movement may switch pump 12 from delivering fluid in inlet 2102 to delivering air to purge inlet 2106, which will reduce or eliminate residual water in the system 10. This purge device 2100 may take various forms and/or include various devices, and as such, the present disclosure may take any form of mechanical, electrical, or electro-mechanical device to perform the operation of the purge as disclosed herein without departing from the scope of the present disclosure.

FIG. 20D illustrates another aspect of the present disclosure.

As shown in FIG. 20D, the latch 2002 may be coupled to a pivot 2006 and the stop 2008 may move in a linear fashion with respect to the latch 2002. As motor 2300 rotates, gears 2302-2308 rotate at various speeds. Additional gears may be included to change the gear ratio between the rotational motion of motor 2300 and gears 2302-2308 as desired.

Gear 2306 is coupled to a spring loaded assembly within mechanism 2000, and, as nut 2310 moves up and down on threads 2312, stop 2008 is moved with respect to latch 2002. At a certain point, the nut 2310 has traversed enough of the threads 2312 to allow latch 2002 and stop 2008 to be disengaged, and latch 2002 can then be opened to access the brew head 18.

When the motor 2300 is reversed, the rotation of gear 2306 is reversed, and the nut then travels in the opposite direction on threads 2312, thus re-engaging the stop 2008 with latch 2002. This may be considered a “locked” position for mechanism 2000.

Depending on the shape and design of stop 2008 and latch 2002, various configurations of locked, unlocked, and other forms of access may be achieved within one or more aspects of the present disclosure. The present disclosure is not to be limited to the embodiments and/or aspects as disclosed herein, but instead is envisioned as including a broad range of shapes, designs, and positions for the stop 2008 and latch 2002 within the scope of the present disclosure.

Similarly, motor 2300 turns gear 2302, which moves nut 2314 on threads 2316. As motor 2314 rotates, the threads 2316 are forced against the threads of the nut 2316 in an opposite direction for threading the nut 2314 to the threads 2316, causing the nut 2316 to be forced away from the motor 2300. This pushes against seal 2318 and exposes atmospheric pressure at purge inlet 2106 and releases pressure on (or forces air into) pump inlet 2320 which is coupled to pump 12. As such, conduits within system 10 are filled with air, either continuously or in bursts as motor 2300 rotates and raises and lowers nut 2314 on threads 2316, to assist in removal of liquid in the conduits of system 10. This purge cycle may reduce dripping from the brew head 18 and/or increase the performance of system 10.

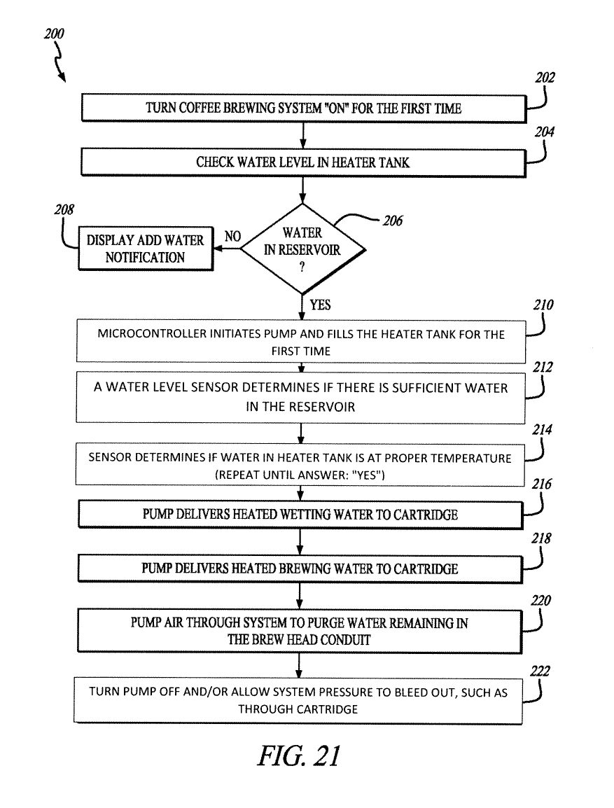

FIG. 21 illustrates one method (200) for operating the beverage brewing system 10 in accordance with the embodiments disclosed herein. It is understood that certain steps can be omitted and other steps may be added, such as intermediate steps, and methods of operation according to the present disclosure can take many forms. With regard to the method (200), the first step (202) can be to turn the beverage brewing system 10 “on” for the first time. Powering “on” the brewing system 10 activates the electronics, including the microcontroller 50 and other features operated by the microcontroller 50, such as the emitter 100, as described herein. The next step (204) can be for the now powered brewing system 10 to check the water level in the heater tank 16. This can be quickly accomplished by reading feedback from the photoreceptor 104. In one embodiment, if the heater tank 16 is empty, the photoreceptor 104 will send positive feedback to the microcontroller 50 that the light beam 102 is being received. Alternatively, with respect to the embodiment described above with respect to FIGS. 17-18, occlusion of the light beam 102 may indicate that the heater tank 16 is empty. This should be the case the first time the brewing system 10 is turned “on”, unless the system 10 already has water in the heater tank 16.

As such, the next step (206) can be for the system 10 to determine if there is any water in the reservoir 14 that can be used to fill, or at least partially fill, the heater tank 16. The microcontroller 50 may receive feedback from the water level sensor 38 (indicating whether a threshold amount of water is in the reservoir 14) or one or more sensors that provide feedback regarding the specific quantity of water in the reservoir 14. If there is no water in the reservoir 14, then the system 10 may display a notification to “add water” in step (208). Alternatively, if the reservoir 14 has enough water, the microcontroller 50 can activate the pump 12 to start filling the heater tank 16 for the first time as part of step (210). The pump 12 can continue pumping water from the reservoir 14 until the heater tank water level sensor 90 indicates the heater tank 16 is full, or until the microcontroller 50 determines the reservoir 14 is out of water, e.g., through feedback from the low water level sensor 38 or the like.

When the pump 12 turns “on” as part of the initial filling stage, it can run at a substantially constant speed (i.e., constant voltage) to pump water from the reservoir 14 through the first conduit 40 and into the heater tank 16 via the inlet 78. At this point, the first solenoid valve 126 can be closed (for the embodiments disclosed with respect to FIGS. 1 and 19) and the second solenoid valve 132 is open. The first check valve 46 (if included) can open to allow water from the reservoir 14 to flow therethrough in the forward direction once the pump 12 creates sufficient pressure in the first conduit 40 to exceed the cracking pressure of the first check valve 46 (if included). The water can then flow through the flow meter 48 (if included, as in FIG. 1) en route to the pump 12. The flow meter 48 (if included) can determine and track the volume of water pumped from the reservoir 14. Although, in alternate embodiments as shown in FIGS. 7 and 19, the water volume pumped from the reservoir 14 may be determined based on the attributes of the pump 12, as described herein, or in another manner. The water can then flow through the pump 12 and through the second check valve 88 (if included), assuming the water pressure is greater than its cracking pressure. In an embodiment that includes both the first and second check valves 46, 88, it is preferred that they have same cracking pressure. Thus, if the flow pressure is sufficient to open the first check valve 46, it should also be sufficient to open the second check valve 88. The water can then flow into the bottom of the heater tank 16 via the inlet 78 and start to fill the heater tank 16. Step (210) may optionally include creating an air blanket (not shown) at the top of the heater tank 16.

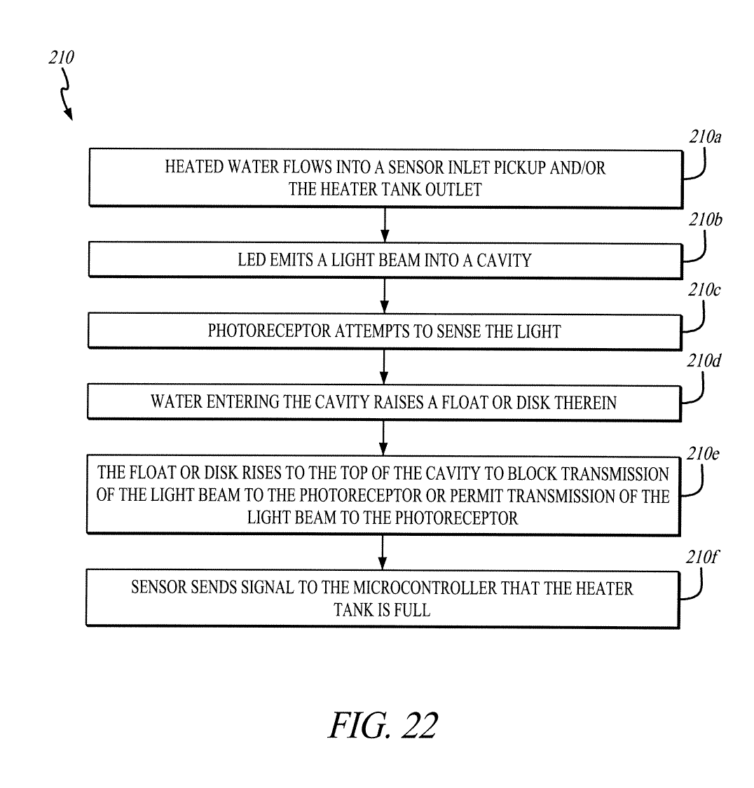

FIG. 22 more specifically illustrates embodiments of the step (210) for initiating the pump 12 and filling the heater tank 16, and using any of the heater tank water level sensors 90, 90′, 90″, 90′″ to determine if the heater tank 16 is full, or requires more water. As the heater tank 16 fills with water, continued pumping results in water flowing into the sensor inlet pickup 94 and/or the heater tank outlet 80 as part of step (210a). As mentioned above, the emitter 100 emits the light beam 102 into the cavity 92 (210b) and the photoreceptor 104 either receives or does not receive the light beam 102, and provides feedback to the microcontroller 50 accordingly, as part of step (210c). This feedback will indicate whether the heater tank 16 is full or not. For example, for the sensors 90, 90′″, the heater tank 16 is not full when the float 106′ is at the bottom of the cavity 92 as shown in FIGS. 14 and 17. In the embodiment shown in FIG. 14, reception of the light beam 102 by the photoreceptor 104 indicates that the heater tank 16 is not full, while in the embodiment shown in FIG. 17, non-reception of the light beam 102 by the photoreceptor 104′″ indicates that the heater tank 16 is not full. Water entering and filling the cavity 92 also causes the float 106′ to rise (210d). In step (210e), the float 106′ rises to the upper portion of the cavity 92 as generally shown in FIGS. 15 and 18. In the first embodiment shown in FIG. 15, the float 106′ occludes transmission of the light beam 102 to the photoreceptor 104, and the sensor 90 or the like may relay a fill condition to the microcontroller 50. Conversely, in the embodiment shown in FIG. 18, the float 106′ no longer occludes transmission of the light beam 102 to the photoreceptor 104′″, and the sensor 90′″ may similarly relay a fill condition to the microcontroller 50. Basically, in either embodiment, the sensor 90, 90′″ is able to relay a signal to the microcontroller 50 indicating that the heater tank 16 is full (210f) when the float 106′ is at the top of the cavity 92. The sensors 90′, 90″ may operate in a similar manner. Thereafter, the system 10 shuts “off” the pump 12 as part of the final step (210f) shown in FIG. 22.

Preferably, the heater tank 16 is configured to remain full or substantially full at all times after the initial fill cycle is completed as part of step (210), such that a brew cycle after the initial brew cycle may begin at step (212), (214), (216), or another step after step (210). In this respect, the microcontroller 50 may be programmed to maintain the heater tank 16 in a full state at any given point in the future through periodic continued monitoring of the heater tank water level sensor 90, 90′, 90″, 90′″ or by other methods disclosed herein or known in the art. At this stage, since the heater tank 16 is full of water, movement of water from the reservoir 14 to the heater tank 16 by the pump 12 causes a commensurate amount of water in the heater tank 16 to be displaced or expelled out through the sensor outlet 96 and into the third conduit 118 for delivery to the brewer head 18, as described in detail herein.

Furthermore, the heater tank 16 preferably can remain filled with water throughout remaining steps (216)-(222). In this respect, the pump 12 supplies water to the brew cartridge 22 in steps (216) and (218) by pumping water from the reservoir 14 into the heater tank 16. A volume of water equal to the amount of water pumped into the heater tank 16 is displaced therefrom into the third conduit 118 because the heater tank 16 is completely filled. For example, for a 10 oz. serving size, the pump 12 pumps a total of 10 oz. of water from the reservoir 14 into the heater tank 16, which, in turn, displaces 10 oz. of heated water therefrom into the third conduit 118 and the brew cartridge 22 for brewing a cup (or more) of beverage (e.g., coffee) into the underlying mug 26 or the like. Of course, the amount of water displaced from the water reservoir 14 to the heater tank 16 during the brew cycle may be altered somewhat to account for water in the third conduit 118.

In one embodiment, the system 10 may maintain the heater tank 16 in a filled state after the initial fill sequence described above, regardless of the temperature of the water therein. In this respect, the pump 12 may operate in constant closed loop feedback with the heater tank level sensors 90, 90′, 90″, 90″. Normally, the heating element 82 maintains the water at or near the desired brewing temperature (e.g., 192° Fahrenheit). As discussed herein, the water temperature in the heater tank 16 may fall below the preferred brew temperature when the system 10 is inactive for an extended duration or when an energy saver mode is activated. The water in the heater tank 16 may thermally contract when it cools. As such, the water level may fall below the heater tank water level sensor 90, causing the microcontroller 50 to activate the pump 12 to displace additional water from the reservoir 14 into the heater tank 16. The microcontroller 50 may turn the pump 12 “on” and “off” as needed to ensure the heater tank 16 remains substantially constantly filled with water. If the water in the heater tank 16 is below the desired brew temperature when the brew cycle is initiated, the heater element 82 can turn “on” to increase the temperature of the water therein to the appropriate brewing temperature. Accordingly, the water therein thermally expands as it is heated. Since the heater tank 16 is already substantially or completely full of water, thermal expansion may cause some water to flow out through the normally “open” second solenoid valve 132 and into the vent 128. The water in the vent 128 may be evacuated or dispensed at the end of each brew cycle in accordance with the embodiments disclosed herein.

In a preferred embodiment, the microcontroller 50 may use feedback from the temperature sensor 84 and the heater tank level sensor 90 to self-learn temperature and related heater tank 16 fill levels, although other embodiments are possible, such as those using a temperature/fill level look-up table. In this respect, the microcontroller 50 may be able to better maintain the water level in the heater tank 16 in a manner that reduces or eliminates water overflow from thermal expansion, as described above. That is, if the microcontroller 50 receives feedback that more than a few oz. of water are flowing into the vent 128, the microcontroller 50 may adjust the operation of pump 12 and the heating element 82 by, e.g., increasing the temperature of the water in the heater tank 16 before adding additional water, to reduce overflow as a result of thermal expansion.

Alternatively, the system 10 may purposely overfill the heater tank 16 beyond the heater tank water level sensor 90, 90′, 90″, 90′ so that water fills the vent 128 with some water spilling back into the water reservoir 14. Here, the system 10 establishes a constant or static starting point with a known quantity of water in the heater tank 16 and the vent 128 for use in a brew cycle.

In an alternative embodiment, the brewing system 10 may not cycle the pump 12 to maintain the heater tank 16 in a completely filled state when the water therein thermally condenses as a result of cooling. Here, the system 10 allows the water level in the heater tank 16 to fall below the heater tank water level sensor 90, 90′, 90″, 90′″. Upon initiation of a brew cycle, water in the heater tank 16 is increased in temperature until the desired brewing temperature is reached. At this point, the system 10 may determine whether the heater tank is full by reading the heater tank water level sensor 90, 90′, 90″, 90′″. If the water level is too low, the pump will displace additional water from the reservoir 14 to fill the heater tank 16; in one such embodiment, the total water displaced is more than the desired brew size such that the extra water can result in a filled heater tank 16 after the brew cycle.

Additionally, the microcontroller 50 may activate the heating element 82 during the initial filling process described above to heat the water in the heater tank 16 to the desired brew temperature. This way, the water in the heater tank 16 is immediately pre-heated upon entry to the heater tank 16, thereby reducing the time for the beverage brewing system 10 to prepare for a brew cycle. In one embodiment, the heating element 82 may sufficiently preheat the water in real-time to the desired brewing temperature upon entry to the heater tank 16. In an alternative embodiment, it may take longer for the heating element 82 to heat the water to the desired brewing temperature. In this respect, the water in the heater tank 16 may be initially below the preferred brewing temperature when the heater tank 16 is full. Accordingly, the heating element 82 continues to heat the cooler water at the bottom of the heater tank 16. The heated water at the bottom of the heater tank 16 rises as it becomes less dense than the cooler water above, which now falls to the bottom of the heater tank 16 and into closer proximity with the heating element 82. This process continues until the entire (or substantially the entire) volume of water in the heater tank 16 is at the desired brew temperature. During the heating process, the temperature sensor 84 tracks or measures the temperature of the water in the heater tank 16 to determine when the water is at the correct or desired brew temperature. Optionally, an externally viewable temperature LED (not shown) may provide visual notification that the heating element 82 is active, or that the water is at an optimal brew temperature and/or ready to initiate a brew cycle. Another feature of the brewing system 10 may permit the user to manually set the desire brew temperature using an externally accessible control panel.

Additionally, the microcontroller 50 may receive periodic continuous feedback readings from the temperature sensor 84 after the heater tank 16 has been filled with water. In this respect, the microcontroller 50 may turn the heating element 82 “on” and “off” at periodic intervals to ensure the water in the heater tank 16 remains at an optimal brewing temperature so a user can initiate a brew cycle without waiting for the brewer to heat the water therein. Alternatively, the microcontroller 50 can be pre-programmed or manually programmed to activate the heating element 82 to ensure the water temperature is at the optimal brewing temperature at certain times of the day (e.g., morning or evening), instead of keeping the heater tank water at the desired brew temperature all day long. In this respect, it may be possible for the user to set the times when the water in the heater tank 16 should be at the optimal temperature for brewing a beverage.

Once the heater tank 16 is full and the water is at the optimal brewing temperature, the brewing system 10 is ready to initiate a brew cycle. The control panel may allow the user to set the desired brew size (e.g., 6 oz., 8 oz., 10 oz., etc.). After selection of the desired brew size, the system 10 may then read the water level sensor 38 (e.g., with the microcontroller 50) in the reservoir 14 to determine if the reservoir 14 contains a sufficient volume of water to brew the desired quantity of beverage, as part of step (212). If the reservoir 14 does not contain an adequate quantity of water, the brewing system 10 may present a “low” or “no” water indication and prompt the user to add water to the reservoir 14 similar to step (208). A sufficient volume of water in the reservoir may be necessary in order to effectively displace the appropriate amount from the heater tank. Alternatively, in accordance with the systems 10′, 10″ shown in FIGS. 7 and 19, the microcontroller 50 may determine whether the reservoir 14 includes water based on load and current measurements of the pump 12. In this embodiment, and as described above, it may not be necessary to include the water level sensor 38. In a next step such as the step (214), a sensor within the heater such as the temperature sensor 84 can be used to determine whether the water within the tank is at an appropriate temperature; if it is not, in some embodiments the water can be heated until an appropriate temperature is reached prior to proceeding to the next step. A brew cartridge 22 can be loaded into the brew chamber 20 at any point, but in a preferred embodiment this step is performed at least before the delivery of the heated wetting water in step (216) (although many step orders are possible).

Just prior to or simultaneously with the start of step (216), the system 10 can close the second solenoid valve 132 to prevent the pump 12 from displacing heated water through the vent 128 during the brew cycle. While a small amount of water may enter the vent 128 in front of the second solenoid valve 132, closing the second solenoid valve 132 blocks the passage of water therethrough and otherwise requires displaced water to travel forward into the third conduit 118. An increased pressure in the third conduit 118 can open the brew head check valve 122 so as to be able to deliver pressurized heated water to the rotating inlet needle 120.

Next, as part of step (216), the pump 12 delivers a small predetermined amount of heated water to the brew cartridge 22 to initially pre-heat and pre-wet the beverage medium 24 therein. In one embodiment, this delivery is performed at high pressure and/or flowrate. More specifically, the pump 12 may run at a relatively high voltage (e.g., 80-90% of the maximum voltage) for a relatively short duration (e.g., 10% of the brew cycle) to inject a relatively small quantity of heated water (e.g., 1 oz. or 10% of the total brew volume or serving size) into the brew cartridge 22. The pump 12 may run for a predetermined time period (e.g., 10 seconds) or until the pump amperage spikes, which can serve to indicate that the heated water has wetted the beverage medium 24. For example, a 12 volt pump may run at 10-11 volts to inject 1 oz. of heated water into a brew cartridge 22 designed to brew a 10 oz. serving. Obviously, the beverage brewer system 10 may run the pump 12 at a higher or lower voltage or inject more or less heated water as needed or desired. Once in the brew cartridge 22, the heated water intermixes with the beverage medium 24 to initially pre-wet and pre-heat the same. This initial quantity of heated water preferably may not cause the brewed beverage to exit the brew head 18 (or cause only very little to exit). The rotating inlet needle 120 can ensure homogenous wetting and pre-heating of all or a substantial majority of the beverage medium 24 in the brew cartridge 22. The wetting and preheating of the beverage medium 24 in step (216) can enhance consistent flavor extraction relative to conventional brewing processes known in the art, thereby improving the taste of the resultant beverage (e.g., coffee). Moreover, step (216) can also preheat the third conduit 118, which can thereby prevent any temperature drop in the heated water used to brew the desired beverage later in the brew cycle. Step (216) preferably comprises only a small amount of the total brewing time (e.g., 5-10%).

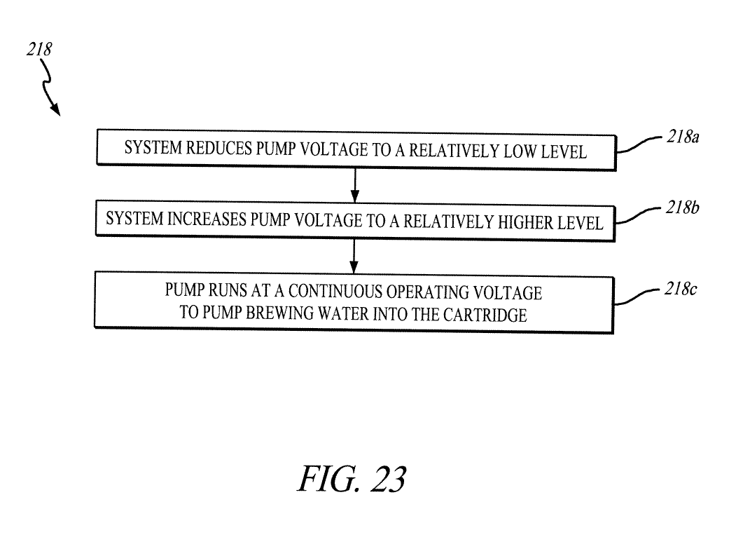

The next step (218) is for the system 10 to pump a predetermined amount of heated water (e.g., 80-90% of the brew volume) from the heater tank 16 into the brew cartridge 22 to brew the beverage. More specifically as illustrated in FIG. 23, the system 10 reduces the voltage supplied to the pump 12 from the relatively high level in step (216) to a lower voltage (e.g., 20% of the total pump voltage) in step (218a), thereby reducing the pressure and flow rate of water to the brew cartridge 22 relative to step (216). Once at this voltage, the system 10 can gradually increase the pump voltage to an operating voltage, as shown in step (218b). The operating voltage at the end of step (218b) may still be less than the maximum pump voltage (e.g., 40%) and can be less than the voltage during the pre-heat/pre-wet stage. The voltage increase in step (218b) may be a ramp function (i.e., a substantially continuous linear increase in voltage), a stair-step function (i.e., the voltage increases in a series of discrete steps), or any other method of increasing the pump voltage as desired. At some point, the pump 12 may stop increasing and run at an operating voltage (i.e., a continuous voltage) to continue the brew cycle until the desired quantity of beverage is brewed (218c). For example, a 12 volt motor running at 10-11 volts in step (216) may drop to 2 volts in step (218a) and then ramp up to 4 volts in step (218b) and continue at that voltage until the pump 12 has delivered a total of 9 oz. of heated water (i.e., 1 oz. of heated wetting water and 8 oz. of heated brewing water) as part of a 10 oz. serving. In this respect, the heated water flows from the heater tank 16 into the brew cartridge 22 in the same manner as the heated pre-wetting water in step (216), albeit at a lower pressure. Step (218) preferably comprises the majority of the brewing time (e.g., 80-90%).

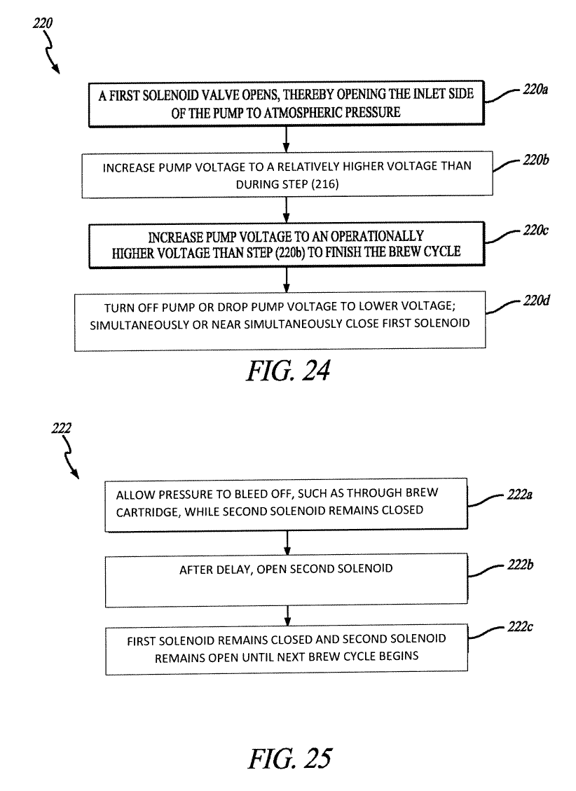

The next step (220) can be for the pump 12 to pump air through the system 10 to purge the remaining water in the third conduit 118. An intermediate step beforehand is possible, where the total brew cycle flow (e.g., flow from the reservoir through a flowmeter or the pump, which can act as a flowmeter as previously described) can be measured to have reached the desired total brew flow or a point just below the desired total brew flow, such that the system knows it should stop pumping water and begin pumping air. After completion of step (218), a relatively small amount of heated water (e.g., 10% of the total brew volume, or about 1 oz.) may remain in the third conduit 118. The amount of water displaced from the heater tank 16 during steps (216) and (218) may not equal the total amount of water delivered to the brew cartridge 22 because the third conduit 118 has a positive volume that stores a portion of the displaced water. Thus, to brew the entire serving size, this residual water must be displaced or otherwise substantially purged from the third conduit 118. As illustrated in FIG. 24, the first step (220a) is for the first solenoid valve 126 to open, thereby opening the inlet side of the pump 12 (i.e., the first conduit 40) to atmospheric air. As such, pressure in the first conduit 40 falls to atmosphere. This permits the first check valve 46 to close because the pressure in the first conduit 40 falls below the cracking pressure of the first check valve 46. Now, the pump 12 pulls and pumps air from the air line 124 and into the second conduit 86.

### Purge and Latch Coupling

In the alternative embodiment shown in FIG. 7, the step (220) for pumping air through the conduit system to purge any remaining water in the third conduit 118 can occur as a result of pulling air through the reservoir 14, e.g., after the reservoir 14 runs out of water. As described above, in this embodiment, the pump 12 can continue to pump water until the reservoir 14 is empty. When the water runs out, the first conduit 40 becomes exposed to the atmosphere and the pump draws air into the first conduit 40 through the opening in the reservoir 14. At this point, the microcontroller 50 identifies an amperage drop in the pump 12 and initiates the last phase of the brew cycle, i.e., purging water remaining in the third conduit 118, in accordance with the embodiments disclosed herein.

In step (220b), the pump voltage may immediately or almost immediately increase to a relatively higher voltage (e.g., 70% or 80% of the maximum pump voltage) to immediately force a quantity of pressurized air through the second conduit 86, the heater tank 16 and out through the third conduit 118 and into the brew cartridge 22. The pressurized air may bubble through the water in the heater tank 16 because the air is less dense than water. The top of the heater tank 16 can include a dome-shaped nose 98 so the pressurized air can be immediately directed to the heater tank outlet 80 for delivery to the third conduit 118. Residual water or brewed beverage in the third conduit 118 onward is preferably quickly and smoothly evacuated and dispensed from the system 10 and into the underlying mug 26 or the like, as brewed beverage. The third conduit 118 has a relatively smaller diameter than the heater tank 16, which increases the density and flow rate of air traveling therethrough to more efficiently turbulently evacuate and dispense any residual liquid out from the brew head 18. In this respect, the pressurized air and concomitant friction within the third conduit 118 preferably substantially forces all of the water remaining in the third conduit 118 into the brew cartridge 22.

The pump 12 may steadily increase to an even higher voltage (e.g., 80-90% of the maximum pump voltage) as part of a finishing step (220c). The voltage increase in step (220c) may be a ramp function (i.e., a substantially continuous linear increase in voltage), a stair-step function (i.e., the voltage increases in a series of discrete steps), or any other method of increasing pump voltage known in the art. In this respect, the pump 12 can continue to draw air into the system 10 through the air line 124 (or through the reservoir 14 in accordance with the embodiment shown in FIG. 7), thereby forcing any remaining water from the third conduit 118 into the brew cartridge 22. For example, a 12 volt pump may jump from 4 volts in step (218c) to 9 volts in step (220b) and increase to 11 volts in step (220c) to quickly and efficiently force the water remaining in the third conduit 118 into the brew cartridge 22 to complete the 10 oz. serving. The system 10 can then turn the pump 12 “off” (220d). Alternatively, the pump 12 may drop to a relatively lower voltage (e.g., 2 volts) instead of shutting off, as part of step (220d). The pump 12 pumps purging air through the beverage brewing system 10 until the desired serving size (e.g., 10 oz.) of beverage is brewed. The total runtime of step (220) can be relatively short (e.g., 5-10%) compared to the total brew time. Furthermore, positioning the entrance of the third conduit 118 above the heater tank 16 allows any water remaining in the third conduit 118 and behind the brew head check valve 122 to drain into the heater tank 16 under the influence of gravity, upon completion of step (220). In this respect, the third conduit 118 is preferably substantially free of water after the system 10 finishes step (220).

Upon turning off the pump, the first solenoid valve 126 can close, and in one embodiment remains closed until step the pump needs to pump air in the following brew cycle. At this point in the brew cycle, the heater tank 16 and the second and the third conduits 86, 118 may be under a positive pressure from the pump 12 during the brew cycle, the release point being the pressure drop in the brew cartridge 22 across the bed of beverage medium 24. As such, this pressure can cause the brew head 18 to drip after the brewing process has ended. Upon turning off the pump, the second solenoid valve 132 can remain closed for a set period of time (e.g., a delay, such as a delay of a few seconds) to allow pressure to bleed off, such as to bleed off through the cartridge, as shown in step (222a). This delay can serve other purposes in addition to or in place of pressure bleed off, such as to allow for the usage of one or more safety features. After at least some pressure has been bled off, the second solenoid valve 132 can be opened, thereby opening the third conduit 118 to atmospheric pressure. The pressure on the outlet side of the heater tank 16 (i.e., the third conduit 118) then drops to that of the atmosphere. Pressure, such as remaining pressure after bleed-off, in the third conduit 118 can be relieved into atmosphere via the open end of the vent 128. Water forced out of the open end of the vent 128 (if any) preferably drains into the reservoir 14. In this reduced pressure state, the brew head check valve 122 can close as pressure falls below cracking pressure. As such, any residual water in the third conduit 118 falls back into the heater tank 16 due to gravity because there is insufficient pressure to open the brew head check valve 122. Thus, water may not drip out of the brew head 18 (or only a minimal amount may drip) because the brew head check valve 122 prevents any residual water from flowing thereto. If the pump 12 continued to run at a relatively lower voltage in step (220d), the system 10 shuts the pump 12 “off” after a relatively short amount of time (e.g., 2 seconds). Obviously, this is only necessary if the pump 12 does not turn “off” in step (220d). At this point, the brew process is complete and the user may enjoy a hot cup (or more) of freshly brewed beverage, such as coffee. The first solenoid valve 126 can remain closed and the second solenoid valve 132 can remain open until the following brew cycle is engaged.

It is worth noting that several voltage cycles involving increasing and decreasing pump voltage in different manners and at different times have been described above. These voltage cycles are exemplary only. At various points within the initial wetting pumping, brewing pumping, and air pumping stages, voltage can be increased and/or decreased, both within that specific pumping stage and from stage to stage. Further, no voltage change may occur in some embodiments during these stages where a voltage change above was described.

Although several embodiments have been described in detail for purposes of illustration, various modifications may be made without departing from the scope and spirit of the disclosure.

What is claimed is:

1. A brewing system, comprising:
a water conduit system;
a brew head coupled to the water conduit system and configured to selective receive and retain a quantity of beverage medium to be brewed by heated water delivered by the water conduit system during a brew cycle;
an inlet nozzle coupled to the brew head, in which the inlet nozzle is moved with respect to the beverage medium during the brew cycle to create a fluidized mixture of hot water and beverage medium within the brew head during the brew cycle; and
a latch, coupled to the inlet nozzle, in which a rotation of the inlet nozzle in a first direction engages the latch and a rotation of the inlet nozzle in a second direction disengages the latch.

2. The brewing system of claim 1, further comprising a speed controller for changing a speed of movement of the inlet nozzle.

3. The brewing system of claim 1, wherein the latch in the engaged position locks the brew head.

4. The brewing system of claim 1, wherein the latch in the disengaged position permits access to the brew head.

5. The brewing system of claim 1, further comprising a purge mechanism, coupled to the inlet nozzle, to purge the brewing system with air.

6. The brewing system of claim 5, in which the purge mechanism is coupled to the latch, such that the brewing system is purged while the latch is engaged.

7. A method for preparing a beverage, comprising:
delivering heated water through an inlet nozzle positioned in a brew head to a quantity of beverage medium;
moving the inlet nozzle in at least one direction with respect to the beverage medium during a brew cycle;
latching the brew head via the motion of the inlet nozzle;
creating a fluidized mixture of hot water and beverage medium within the brew head during a brew cycle; and
dispensing the fluidized mixture from the brew head.
